(19) United States
(12) Patent Application Publication
(10) Pub. No.: US 2005/0119371 A1
(43) Pub. Date: Jun. 2, 2005

(54) Bio-based epoxy, their nanocomposites and methods for making those

(75) Inventors: Lawrence T. Drzal, Okemos, MI (US); Manjusri Misra, Lansing, MI (US); Hiroaki Miyagawa, East Lansing, MI (US); Amar K. Mohanty, Lansing, MI (US)

Correspondence Address: McLeod & Moyne, P.C., 2190 Commons Parkway, Okemos, MI, 48864, US

(73) Assignee: Board of Trustees of Michigan State University, East Lansing, MI (US)

(21) Appl. No.: 10/966,624

(22) Filed: Oct. 15, 2004

Related U.S. Application Data
(60) Provisional application No. 60/511,258, filed on Oct. 15, 2003.

(51) Int. Cl. C08L 63/00

(52) U.S. Cl. 523/400

(57) ABSTRACT

Precursor epoxidized vegetable oil or ester derivatives of the oil is mixed and cured with a biodegradation resistant epoxy resin precursor to provide a cured composition. The composition preferably includes a filler as a composite and/or continuous carbon fibers as a mat or strand. Novel epoxidized linseed/soybean oil compositions are described. The compositions are useful in place of the standard epoxy resin compositions making articles of manufacture.

### CROSS-REFERENCE TO RELATED APPLICATIONS

This application is based for priority on U.S. Provisional Application Ser. No. 60/511,258 filed Oct. 15, 2003.

### STATEMENT REGARDING FEDERALLY SPONSORED RESEARCH OR DEVELOPMENT

The present invention was funded under Natural Science Foundation No. 0122108. The U.S. government has certain rights to this invention.

### STATEMENT REGARDING GOVERNMENT RIGHTS

Not Applicable

### BACKGROUND OF THE INVENTION

(1) Field of the Invention

The present invention relates to a bio-based thermoset epoxy resin prepared from an epoxy resin precursor which resists degredation copolymerized with an epoxidized vegetable oil precursor. This invention also relates to inorganic- or carbon-reinforced bio-based thermoset polymer nanocomposite materials, and is more specifically related to an anhydride-cured bio-based epoxy nanocomposites reinforced by an organoclay, surface treated alumina nanowhiskers, vapor grown carbon fibers, and fluorinated single wall carbon nanotubes and the method of preparing the same.

(2) Description of Related Art

Research and development of nanocomposites consisting of exfoliated smectite clays in cross linked polymers have been growing, and the utility of using clay platelets in polymers to create nanocomposites having properties greater than the parent constituents has been well reported over the past decade (LeBaron P C, Wang Z, Pinnavaia T J. Polymer-layered silicate nanocomposites: an overview. Applied Clay Science 1999; 15 (1-2): 11-29). Although nylon-6 has been the primary matrix material investigated (U.S. Pat. Nos. 4,810,734; 5,385,776 and 6,057,035) (Kojima Y, Usuki A, Kawasumi M, Okada A, Fukushima Y, Kurauchi T, Kamigaito O. Mechanical-properties of Nylon 6-clay hybrid. J. Mater. Res. 1993; 8 (5): 1185-1189), polymer-based clay nanocomposites have been developed with various polymers such as polyester (U.S. Pat. Nos. 6,034,163; 6,156,835; 6,359,052), polypropylene (Hasegawa N, Kawasumi M, Kato M, Usuki A, Okada A. Preparation and mechanical properties of polypropylene-clay hybrids using a maleic anhydride-modified polypropylene oligomer. Journal of Applied Polymer Science 1998; 67 (1): 87-92), polystyrene (Noh M W, Lee D C. Synthesis and characterization of PS-clay nanocomposite by emulsion polymerization. Polymer Bulletin 1999; 42 (5): 619-626), polyimide (Tyan H L, Wei K H, Hsieh T E. Mechanical properties of clay-polyimide (BTDA-ODA) nanocomposites via ODA-modified organoclay. Journal of Polymer Science, Part B: Polymer Physics 2000; 38 (22): 2873-2878 and Gu AJ, Kuo SW, Chang FC. Syntheses and properties of PI/clay hybrids. Journal of Applied Polymer Science 2001; 79 (10): 1902-1910), and polyamide (U.S. Pat. Nos. 4,739,007; 6,417,262; 6,548,587). In these studies, it was found that the nanocomposites have splendid characteristics, i.e. remarkably increased elastic modulus, creep resistance, fracture toughness, and flammability resistance.

The substance and advantages of the present invention will become increasingly apparent by reference to the following drawings and the description.

### OBJECTS

It is an object of the present invention to provide novel bio-based epoxy resin and composites with the resin. It is a particularly an object to use expended bio-based materials in the composites. These and other objects will become increasingly apparent by reference to the following description.

### SUMMARY OF THE INVENTION

The present invention relates to a cured epoxy resin composition which comprises an epoxy resin precursor which resists biodegradation, copolymerized with an epoxidized vegetable oil precursor or an epoxidized vegetable oil ester durative of the oil. Preferably, the composition is derived from between about 10 and 80% by weight of the epoxidized vegetable oil precursor. Preferably, a composite contains a filler selected from the group consisting of an organically modified clay, exfoliated nanographite platelets, inorganic nanowhiskers, nanoparticles, nanofibers, carbon nanofibers including vapor grown carbon fibers, untreated and treated carbon nanotubes and combinations thereof. Most preferably the composite contains an intercalated or exfoliated clay. Preferably, composition is derived from the expoxidized vegetable oil precursor which is selected from the group consisting of epoxidized soybean oil, epoxidized linseed oil and mixtures thereof. Preferably, the composition contains an intercalated or exfoliated clay. Preferably, the composition is cured with a curing agent selected from the group consisting of an anhydride and an amine curing agent. Most preferably, this curing agent is methyltetrahydrophthalic anhydride. Also the composition is cured with a curing agent which is a polyether triamine.

The present invention relates to a process wherein the epoxy resin which resists degradation is mixed with the bio-based epoxidized vegetable oil and then cured with a curing agent. The present invention also relates to a process for forming a cured epoxy resin wherein the precursors are mixed with a filler. Preferably, this curing agent is polypropylene triamine. Most preferable the present invention also relates to a process for forming a cured epoxy resin composition which comprises intercalating or exfoliating montmorillonite nanoparticles with the epoxy resin precursors; and curing the precursors with an epoxy resin curing agent. Preferably, the precursors are mixed with a solvent and a clay as the nanoparticles and sonicated to exfoliate the clay and then the solvent is removed. Preferably, the solvent is acetone. Preferably, the precursors are mixed with a solvent and the nanoparticles to disperse the particles homogeneously and then the solvent is removed preferably by vacuum distillation from the precursors and the nanoparticles.

The present invention also relates to a curable epoxy resin composition which comprises a liquid mixture of an epoxy resin precursor which resists biodegradation; an epoxidized vegetable oil or derivative thereof; an epoxy curing agent; and optionally an accelerator wherein the composition is refrigerated to retard curing. Preferably, the composition further comprises a filler selected from the group consisting of an organically modified clay, exfoliate nanographite platelets, inorganic nanowhiskers, nanoparticles, nanofibers, carbon nanofibers including vapor grown carbon fibers, untreated and treated carbon nanotubes and combinations thereof. Preferably, the composition further contains an exfoliated clay and graphite nanoplatets. Preferably, the composition is derived from the epoxidized vegetable oil precursor which is selected from the group consisting of epoxidized soybean, epoxidized linseed oil and mixtures thereof. The present invention also relates to a cured epoxy resin composition comprising an anhydride cured epoxidized linseed oil precursor as the resin.

The present invention also relates to a carbon fiber and bio fiber reinforced composites which comprise the proceeding compositions as well as a process for producing them. The present invention relates to a process of wherein the proceeding compositions are produced by casting, compression molding, resin transfer molding or vacuum assisted resin transfer molding.

The structure of an epoxidized vegetable oil is generally as follows:

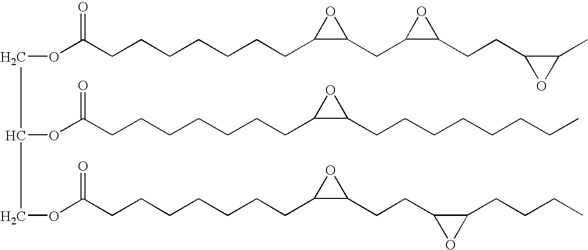

The structure of a derivative ester of the oil is:

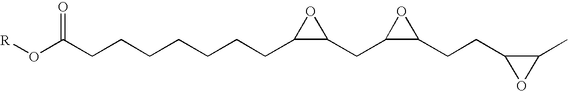

R is alkyl containing 1 to 12 carbon atoms. These derivatives are produced by reacting an alkyl alcohol with the oil. Commercial products are mixtures of the esters.

### BRIEF DESCRIPTION OF FIGURES

FIG. 1 is a high magnification SEM micrograph revealing organo-montmorillonite clay particle.

FIG. 2 is a high magnification bright-field TEM micrograph revealing sonicated fumed silica nanoparticles.

FIG. 3 is a high magnification bright-field TEM micrograph revealing sonicated spherical alumina nanoparticles.

FIG. 4 is a TEM of a bundle of untreated SWCNT.

FIG. 5 is a TEM of a bundle of fluorinated SWCNT.

FIG. 6 is a schematic drawing of sonication process of clay particles.

FIG. 7 is a drawing illustrating a procedure for processing bio-based epoxy/clay nanocomposites.

FIG. 8 is a drawing illustrating a compression molding process of CFRP having the bio-based epoxy matrix.

FIG. 9 is a low magnification bright-field TEM micrograph revealing excellent dispersion of clay platelets in epoxy matrix with 20 wt. % OEL.

FIG. 10 is a high magnification TEM micrograph revealing excellent exfoliation of clay platelets in epoxy matrix with 20 wt. % OEL.

FIG. 11 is a graph of WAXS patterns of organo-montmorillonite clay and bio-based epoxy/clay nano-composites.

FIG. 12 is a low magnification bright-field TEM micrograph revealing excellent dispersion of alumina nanowhiskers in epoxy matrix with 50 wt. % ELO.

FIG. 13 is a low magnification bright-field TEM micrograph revealing excellent dispersion of VGCF in epoxy matrix with 50 wt. % ELO.

FIG. 14 is a high magnification bright-field TEM micrograph revealing vertical and horizontal cross sections of VGCF dispersed in epoxy matrix with 50 wt. % ELO.

FIGS. 15A and 15B are graphs showing the effect of ELO concentration for anhydride-cured neat epoxy.

FIG. 15A shows storage modulus.

FIG. 15B shows loss factor.

FIGS. 16A and 16B are graphs showing the effect of the addition of 5.0 wt % exfoliated clay to anhydride-cured epoxy.

FIG. 16A shows storage modulus.

FIG. 16B shows loss factor.

FIGS. 17A and 17B are graphs showing DMA measurements for anhydride-cured epoxy/FSWCNT nanocomposites.

FIG. 17A is storage modulus.

FIG. 17B shows loss factor.

FIG. 18 is a graph showing a TGA curve of DGEBF and ELO neat epoxies and their 0.2 wt % FSWCNT nanocomposites.

FIGS. 19A and 19B are graphs showing decomposition temperature of DGEBF and ELO neat epoxies and their 0.2 wt % FSWCNT nanocomposites measured by TGA.

FIG. 19A is initial decomposition temperature.

FIG. 19B is maximum decomposition temperature.

FIG. 20 is a graph showing dependence of glass transition temperature on concentration of anhydride curing agent.

FIG. 21 is a graph showing change of storage modulus of amine-cured epoxy with ELO at 30° C. measured by DMA.

FIG. 22 is a graph showing change of glass transition temperature of amine-cured neat epoxy with increasing the amount of ELO.

FIGS. 23A and 23B are SEM micrographs of different impact failure surfaces of epoxy containing ELO (50 wt. %).

FIG. 23A is ELO neat epoxy (Scale bar=2 μm).

FIG. 23B is 5.0 wt. % exfoliated clay nanocomposites (Scale bar=5 μm).

FIGS. 24A, 24B and 24C are SEM micrographs of different fracture surface of epoxy containing ESO (30 wt. %).

FIG. 24A is neat epoxy in lower magnification (Scale bar=20 μm).

FIG. 24B is neat epoxy in higher magnification (Scale bar=1 μm).

FIG. 24C is exfoliated clay nanocomposites (Scale bar=1 μm).

FIG. 25 is a graph showing change of Izod impact strength of amine-cured neat epoxy with ELO.

FIG. 26 is a graph showing fracture toughness of biobased neat epoxies and their nanocomposites.

FIG. 27 is a graph showing Critical energy release rate of biobased neat epoxies and their nanocomposites.

FIGS. 28A to 28E are SEM micrographs of different fracture surface of epoxy containing ELO (50 wt. %).

FIG. 28A is neat epoxy (Scale bar=20 μm).

FIG. 28B is exfoliated clay nanocomposites (Scale bar=20 μm).

FIG. 28C is intercalated clay nanocomposites (Scale bar=20 μm).

FIG. 28D is alumina nanowhiskers nanocomposites in lower magnification (Scale bar=10 μm).

FIG. 28E is alumina nanowhiskers nanocomposites in higher magnification (Scale bar=5 μm).

FIGS. 29A to 29C are SEM micrographs of different fracture surface of epoxy containing ESO (30 wt. %).

FIG. 29A is neat epoxy (Scale bar=20 μm).

FIG. 29B is exfoliated clay nanocomposites (Scale bar=20 μm).

FIG. 29C is intercalated clay nanocomposites (Scale bar=20 μm).

FIG. 30 is a graph of change of fracture toughness before and after adding 5 wt. % silica and 4 wt. % VGCF.

FIG. 31 is a low magnification SEM micrograph of the fracture surface of 4.0 wt. % untreated VGCF/epoxy nanocomposites.

FIG. 32 is high magnification SEM micrograph showing the pull out of VGCF and the VGCF/epoxy interface.

FIG. 33 is a graph of change of fracture toughness of neat epoxies and their 0.2 wt % FSWCNT nanocomposites with increasing ELO amount.

FIG. 34 is a graph of typical example of stress strain curve of unidirectional CFRP containing different epoxy matrix.

FIG. 35 is a graph of elastic modulus of unidirectional CFRP containing different epoxy matrix.

FIG. 36 is a graph of flexural strength of unidirectional CFRP containing different epoxy matrix.

FIG. 37 is a graph of strain at failure of unidirectional CFRP containing different epoxy matrix.

FIG. 38 is a graph of interlaminar shear strength of unidirectional CFRP containing different epoxy matrix.

FIG. 39 is a graph of typical example of stress strain curve of unidirectional CBFRP containing different epoxy matrix.

FIG. 40 is a graph of elastic modulus of unidirectional CBFRP containing different epoxy matrix.

FIG. 41 is a graph of flexural strength of unidirectional CBFRP containing different epoxy matrix.

FIG. 42 is graph of strain at failure of unidirectional CBFRP containing different epoxy matrix.

### DESCRIPTION OF THE PREFERRED EMBODIMENTS

Since epoxy (U.S. Pat. Nos. 5,554,670; 5,760,106; and 6,548,159) has a wide range of possible applications in different engineering fields, the focus was on bio-based epoxy/clay nanocomposites, whose glass transition temperature T_{g} is absolutely higher than room temperature (RT). The mechanical and thermo-physical properties of epoxy/clay nancomposites prepared by solution technique were investigated. A solution technique is one of the major techniques to achieve excellent dispersion and exfoliation of clay platelets in the epoxy matrix. The organoclay is mixed with solvent and either a main component of epoxy or a hardener. The solvent allows the polymer chain to be absorbed between clay basal layers and then the solvent is evaporated and removed in high temperature under vacuum. This results in intercalation/exfoliation of clay nanocomposites. It was found that the elastic and storage moduli were increased with exfoliated/intercalated clay platelets as well as increased glass transition temperature.

The importance of natural products for industrial applications becomes extremely clear in recent years with increasing emphasis on the environmental issues, waste disposal, and depleting non-renewable resources. Renewable resource-based polymers can form a platform to replace/substitute fossil-fuel based polymers through innovative ideas in designing the new bio-based polymers which can compete or even surpass the existing petroleum-based materials on cost-performance basis with added advantage of eco-friendliness. There is a growing urgency to develop and commercialize new bio-based products and other innovative technologies that can unhook widespread dependence on fossil fuel and at the same time would enhance national security, the environment, and the economy. United States agriculture produces more than 16 billion pounds of soybean oil annually, only 500 million pounds of which is used in industrial application, and frequently carry-over exceeds 1 billion pounds. Similarly linseed oil is available in plenty across the world. Both epoxidized soy bean oil and epoxidized linseed oil are now commercially made by various companies like Atofina Chemical company and such epoxidized vegetable oils finds applications in coatings and in some cases as plasticizer additives. More value-added applications of such epoxidized vegetable oil will give much return to agriculture thereby reducing the burden of petroleum-based products. The petroleum-derived epoxy resins are known for their superior tensile strength, high stiffness, and exceptional solvent resistance. The chief drawbacks of epoxy resins for industrial use are their brittleness and high cost. The toughness of epoxy resins can be improved through blends with e.g. epoxidized soybean/linseed oil (ESO/ELO). Through specific curing agents the epoxidized vegetable oils can also be cured. The blend of epoxy resin and epoxidized vegetable oil or epoxidized vegetable oil in presence of suitable curing systems/additives on reinforcement with organically modified nano-clay, nano-fibers and carbon nanotubes would result in advanced materials for value-added applications in automotives, defense and aero-space applications.

The incorporation of bio-based polymer reinforced by nanoclay platelets would be one of the best combinations for developing environmentally friendly composites if the developed bio-based nanocomposites satisfy the demanding requirements. This investigation is focused on glassy epoxy resins having high glass transition temperature, since these materials have a wide range of applicability. It was found that use of anhydride curing agent is beneficial to increase the ratio of ELO or ESO in the glassy epoxy matrix.

Experiments were carried out with anhydride-cured bio-based epoxy materials and their clay nanocomposites which provided excellent mechanical properties.

EPOXIDED SOYBEAN OIL (ESO) AND EPOXIDED LINSEED OIL (ELO) WERE USED AS FOLLOWS:

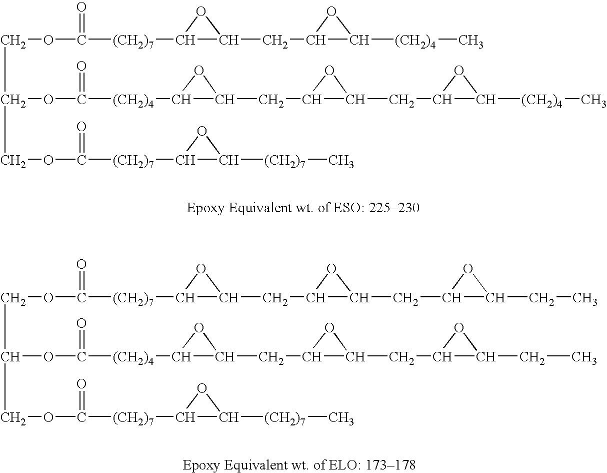

The ratio of ELO or ESO could be increased with the use of anhydride curing agent. It was possible to add up to 20 wt. % ELO or ESO to provide a glassy epoxy with amine curing agent. It was possible to obtain an even higher Izod impact strength due to the mixture of suitable amount of epoxidized vegetable oil. Clay platelets were also exfoliated in this bio-based epoxy matrix using a sonication technique. This resulted in the higher elastic and storage moduli because of the reinforcing effect of clay platelets. Adding clay nanoplatetets occasionally improved even the Izod impact strength compared with a neat epoxy resin.

The new nanocomposites were particularly processed from an anhydride-cured bio-based epoxy matrix and nano-reinforcements, such as organo-montmorillonite clay. The selection of an anhydride curing agent and a bio-based epoxy resulted in an excellent combination producing an epoxy matrix having a higher elastic modulus, a higher glass transition temperature, and a higher heat distortion temperature (HDT) with higher amount of derivatized vegetable oils compared to an amine-cured bio-based epoxy. A sonication technique was used to process the modified clay in the glassy bio-based epoxy network resulting in nanocomposites where the clay platelets were almost completely exfoliated in the epoxy network. Surface treated alumina nanowhiskers, untreated vapor grown carbon fibers (VGCF), and fluorinated single wall carbon nanotubes (SWCNT) were also utilized as nano-reinforcements. These nano-reinforcements were also uniformly dispersed in the bio-based epoxy matrix by the sonication technique. These different processed nanocomposites showed higher storage modulus comparing to the neat epoxy containing the same amount of vegetable oils. Therefore, the lost storage modulus with higher amount of vegetable oils can be regained with different nano-reinforcement. Izod impact strength can be maintained or become even higher after only the exfoliated clay platelets were added to the bio-based epoxy, dependent on the mixture of suitable amount of epoxidized vegetable oil. It was possible to achieve 100° C. as HDT with any different nano-reinforcements. This is a promising fact for future industrial applications in automotive, aeronautical, other transportation systems, defense, and marine industries, recreation equipments, farm equipments, and electronic packaging such as computer mother boards, and the like.

The following are the nano-reinforcements used to produce bio-based epoxy nanocomposites using the sonication technique:
1. Organomontmorillonite clay (Cloisite® 30B, Southern Clay Products, Gonzales, Tex.),
2. Surface treated alumina nanowhiskers (NanoCeram, Argonide Corporation, Sanford, Fla.),
3. Untreated vapor grown carbon fibers (VGCF, Pyrograf III PR-19-PS, Applied Scienced Inc., Cedarville, Ohio), and
4. Fluorinated single wall carbon nanotubes (SWCNT, Carbon Nanotechnologies Inc., Houston, Tex.) Nanocomposites were made using clay loading of 5.0 wt. %, alumina nanowhisker loading of 5.0 wt. %, VGCF loading of 4.0 wt. %, or SWCNT loading of 0.2 wt. %.

To fabricate the nanocomposites, the nanoparticles were sonicated in acetone for 2-5 hours. The epoxy resin and the bio-based modifier were then added and mixed with a magnetic stirrer for another hour. The acetone was removed by vacuum extraction at approximately 100° C. for 24 hours, and then the curing agent (and the accelerator) were blended into the solution with a magnetic stirrer. Anhydride-cured specimens were cured at 80° C. for 4 hours followed by 160° C. for 2 hours: amine-cured specimens were cured at 85° C. for 2 hours followed by 150° C. for 2 hours.

By using these new bio-based epoxy nanocomposites as a new matrix of fiber reinforced plastics (FRP), the inventors have successfully developed multi-phase hybrid composites. The nanoreinforcements can reduce the volume shrinkage, improve the barrier properties, fracture properties. As a result, the new FRP having the better environmental tolerance and interlaminar properties can be obtained.

The largest potential markets of the bio-based epoxy based nanocomposites is in automotive industries, defense equipments, aerospace and marine applications, and electronic packaging. The present invention is unique in selections of not only bio-based modifiers but also curing agents in the development of nanocomposites providing excellent mechanical and thermo-mechanical properties. These “green” nanocomposites can be widely used in high strength structural applications in automotive, defense and aerospace applications, and electronic packaging.

### EXAMPLES OF INVENTION

### Processing of Anhydride- and Amine-cured Bio-epoxy Matrix

The epoxy resin component which resisted biodegradation was Epon 862, diglycidyl ether of bisphenyl F epoxy Resin (DGEBF, Shell Chemical Company, Resolution Performance Products, Houston Tex.). Four different bio-based epoxy resin presessors were used: (1) epoxidized linseed oil (ELO, Vikoflex® 7190, Atofina Chemicals. Inc. Booming Prairie, Minn.); (2) epoxidized soybean oil (ESO, Vikoflex® 7170, Atofina Chemicals. Inc. Booming Prairie, Minn.); (3) octyl epoxide linseedate (OEL, Vikoflex® 9080, Atofina Chemicals. Inc. Booming Prairie, Minn.); or (4) acrylated soybean oil (AS0, CN111, Sartomer, West Chester Pa.) replaced some amount of Epon 862. The ratio of anhydride- and amine-cured functionalized vegetable oils in various combination with DGEBF was from 0 wt. % to 100 wt. %. The mixture of epoxy and modifier was processed with (a) an anhydride curing agent, methyltetrahydrophthalic anhydride (MTHPA), Aradur™ HY 917(Vantico Inc., Brewster N.Y.) and an imidazole accelerator, DY 070 (Vantico Inc.), or (b) an amine curing agent, polyoxypropylenetriamine, Jeffamine® T-403 (POPTA, Huntsman Corporation, Houston Tex.). The ratio by weight of epoxy resin and modifier to curing agent was adjusted to achieve stoichiometry.

A variety of commercial epoxy resins such as Shell Epon 826, 827, 828, 834, 862, Dow DER 331, 332, and Vantico GY281, GY6010, LY 1556 can be used. Derivatives of vegetable oil can be used, i.e. epoxidized soybean oil, epoxidized linseed oil, epoxidized octyl soyate, methyl epoxy soyate, butyl epoxy soyate, epoxidized octyl soyate, methyl epoxy linseedate, butyl epoxy linseedate, and octyl epoxy linseedate, can be added to provide bio epoxy matrices.

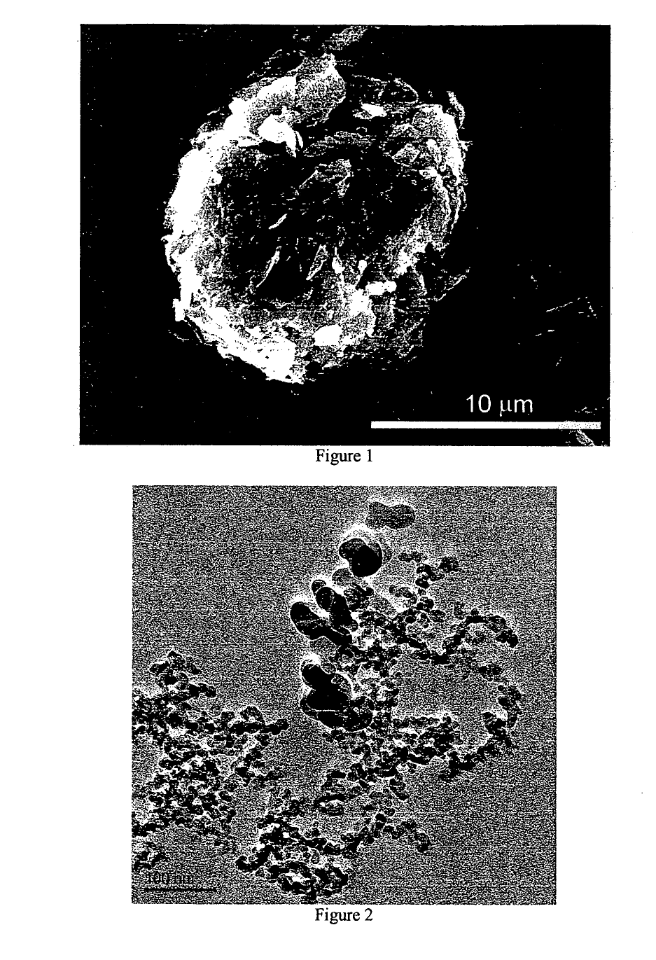

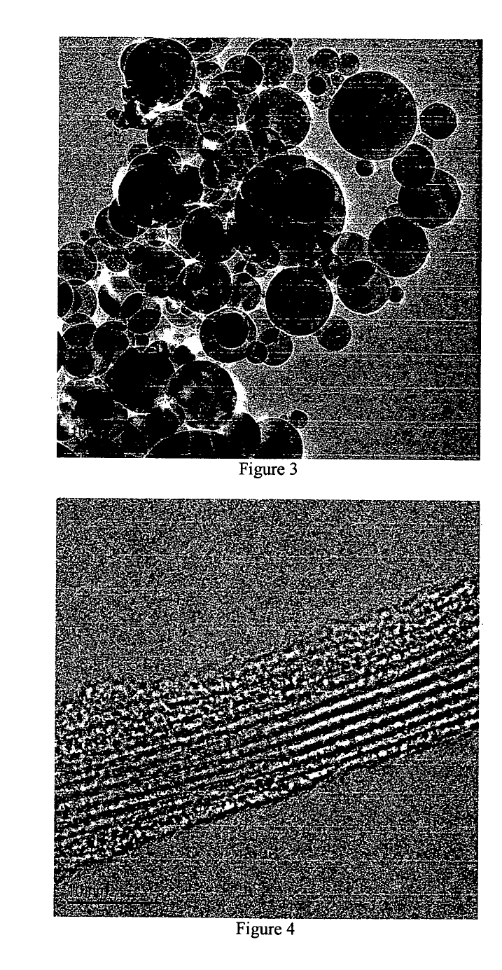

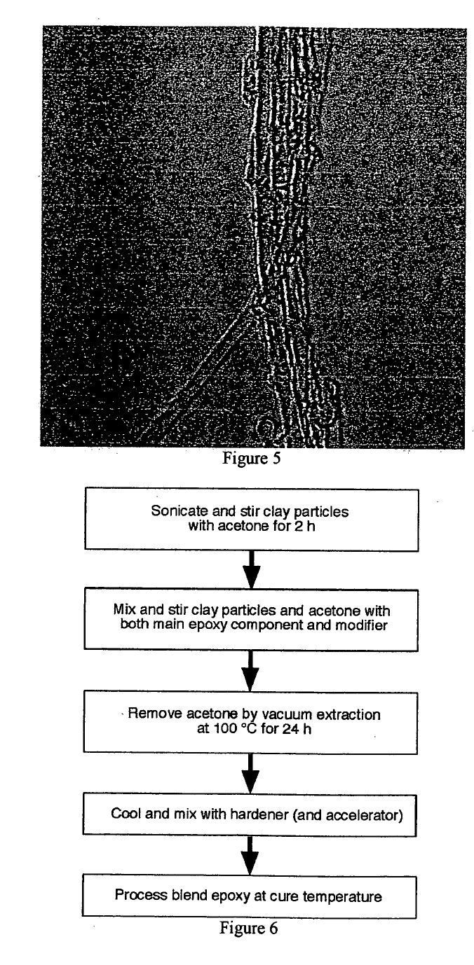

Organo-montmorillonite as shown in FIG. 1, derivatives of inorganic inclusions, i.e. fumed silica nanoparticles as shown in FIG. 2, alumina nanospheres as shown in FIG. 3, and alumina nanowhiskers can be added to provide bio-based epoxy nanocomposites. FIGS. 4 and 5 show the high magnification TEM images of single wall carbon nanotubes (SWCNT). In FIG. 4, it was observed that SWCNT forms a bundle. In general, it is extremely difficult to separate these bundles into individual SWCNT. The diameter was measured as 1.36 nm. FIG. 5 shows the fluorinated SWCNT (Carbon Nanotechnologies Inc., TX). The diameter of the fluorinated SWCNT was measured as 1.09 nm, which is close to the value in FIG. 4. Although the SWCNT still formed a bundle, it seemed that the number of SWCNT forming a bundle was reduced because of fluorination. These CNT fillers are useful to obtain electrically conductive epoxy-based nanocomposites.

### Nanocomposite Fabrication

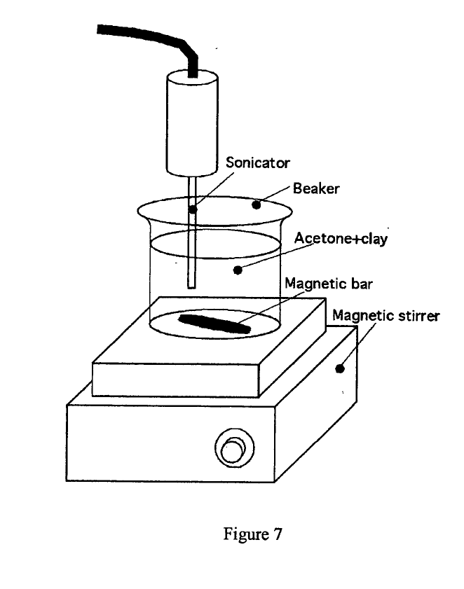

FIGS. 6 and 7 show a schematic drawing and procedure of processing bio-based epoxy/clay nanocomposites with the solution technique. Organomontmorillonite clay Cloisite® 30B (Southern Clay Products, Gonzales Tex.) was blended in the epoxy using solution technique. Cloisite® 30B is a natural montmorillonite modified with methyl, tallow, bis(2-hydroxyethyl) quaternary ammonium (MT2EtOH) ion. Nanocomposites were made using a clay loading of 5.0 wt. %. To fabricate the nanocomposites, the clay particles were sonicated in acetone for 2 hours using a solution concentration of at least 30 liters of acetone to 1 kilogram of clay. The epoxy resin and the modifier were then added and mixed with a magnetic stirrer for another hour. The acetone was removed by vacuum extraction at approximately 100° C. for 24 hours, and then the curing agent (and the accelerator) were blended into the solution with a magnetic stirrer. Anhydride-cured specimens were cured at 80° C. for 4 hours followed by 160° C. for 2 hours: amine-cured specimens were cured at 85° C. for 2 hours followed by 150° C. for 2 hours.

Alumina nanowhisker (NanoCeran™ fibers, Argonide Corporation, Sanford Fla.) was also blended in the epoxy using solution technique. NanoCeran™ fibers have a diameter of 2-4 nm and an aspect ratio of 20-100. Before sonicating the alumina, nanowhiskers, surface treatment was applied with 3-aminopropyltriethoxysilane (3APTS). 3APTS was added to a 95 wt. % ethanol/5 wt. % de-ionized water solution with stirring to yield a 2 wt. % concentration. After 5 min. to obtain hydrolysis and silanol formation, alumina nanowhiskers were dipped into the solution, agitated gently, and removed after a few min. Alumina nanowhiskers were then rinsed free of excess materials by dipping briefly in ethanol. Surface treated alumina nanowhiskers were placed at room temperature for 24 h, followed by at 100 deg C. for 6 h to completely remove the solvent. Nanocomposites were made using alumina nanowhisker loading of 5.0 wt. %. Sonication and curing processes are the same as epoxy/clay nanocomposites mentioned above.

Vapor grown carbon fiber (VGCF, PR-19-PS, Applied Science, Cedarville Ohio) was also blended in the epoxy using solution technique. Nanocomposites were made using VGCF loading of 4.0 wt. %. Sonication and curing processes are also the same as epoxy/clay nanocomposites.

Fluorinated single wall carbon nanotubes (SWCNT, Carbon Nanotechnologies Inc., Houston Tex.) was also blended in the epoxy using the solution technique. Fluorinated SWCNT retain much of their thermal conductivity and mechanical properties. Although SWCNT preferably stick to each other via Van der Waals forces, fluorinated SWCNT can be dispersed excellently in the solutions because the fluorine atoms disrupt the Van der Waals forces, and as a result, this treatment makes it easier to separate and uniformly disperse SWCNT. Epoxy based nanocomposites were made using fluorinated SWCNT loading of up to 0.5 wt. %. To fabricate the nanocomposites, the fluorinated SWCNT were sonicated in acetone for more than 5 hours using a solution concentration of at least 10 liters of acetone to 20 milligrams of fluorinated SWCNT. Curing processes are also the same as epoxy/clay nanocomposites.

### Fabrication of Fiber Reinforced Plastics

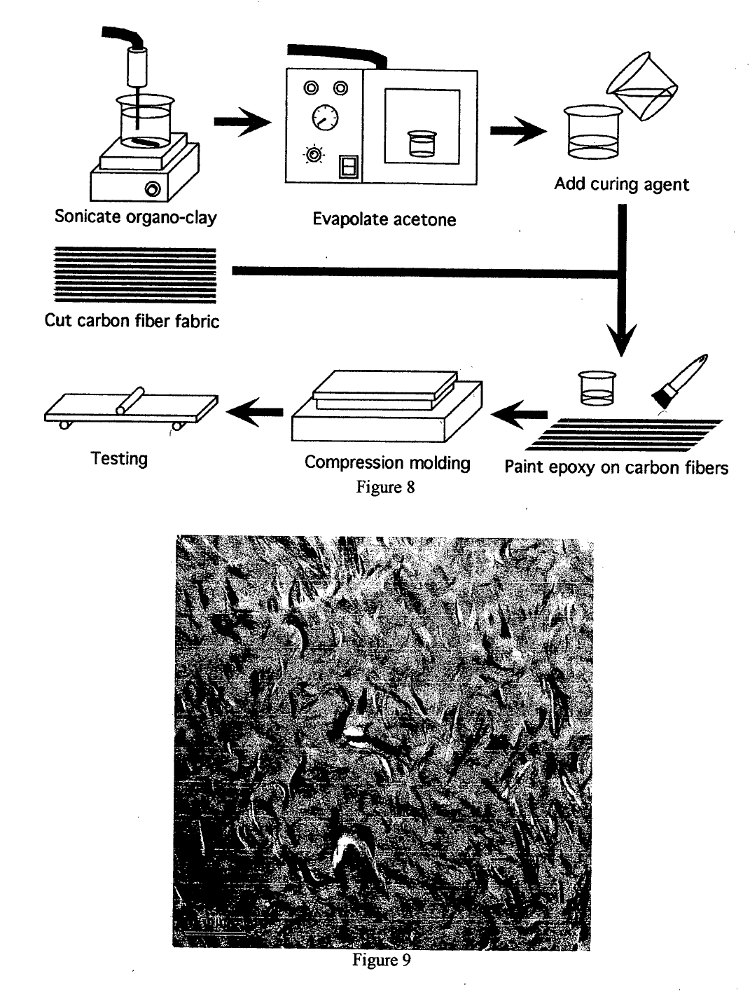

The blend of nanoscale reinforcements, such as organically modified clay and bio-based epoxy resin, results in advanced materials applicable for automotive and aeronautic structures when it is used with high-performance fibers, e.g. carbon fibers. CFRP was processed using this newly-developed bio-based epoxy/clay hybrid nanocomposites mentioned above. FIG. 8 shows the sequence of CFRP process. Unidirectional carbon fiber fabric (Wabo® MBrace CF 130, Watson Bowman Acme Corp., Amherst, N.Y.) was used as the reinforcement carbon fibers. MBrace CF 130 is manufactured from PAN-based carbon fibers (Torayca T 700, Toray, Japan). This carbon fiber fabric was firstly cut into 152 mm length by 50.8 mm width (6 in. by 2 in.). Four different matrices, pure DGEBF, neat bio-based epoxy with 50 weight percent ELO, 2.5 weight percent exfoliated clay nanocomposites with 50 weight percent of ELO, and 5.0 weight percent intercalated clay nanocomposites with 50 weight percent of ELO, were used to process CFRP. As discussed above, organomontmorillonite clay, Cloisite® 30B (Southern Clay Products), was blended in the epoxy using the solution technique. Cloisite® 30B is a natural montmorillonite modified with methyl, tallow, bis(2-hydroxyethyl) quaternary ammonium (MT2EtOH) ion as noted above. 2.5 weight percent exfoliated clay nanocomposites were processed by the same sonication method mentioned above. To fabricate 5.0 weight percent intercalated clay nanocomposites, organo-montmorillonite clay were simply added to DGEBF and ELO, and then mixed by a magnetic stirrer for an hour. These matrixes were coated on the unidirectional carbon fiber fabrics, and this was repeated to layup 10 layers. Finally, the CFRP were processed by compression molding as in FIG. 8.

Carbon fiber/bio fiber reinforced plastics (CBFRP) were also processed using the same technique. Woven jute fiber fabric was used in addition to the unidirectional carbon fiber fabric (Wabo® MBrace CF 130). The layer sequence of CBFRP was [C/B/B/C/C/B/B/C], where C and B stand for carbon fiber and bio fiber fabrics, respectively.

Flexural tests were conducted to understand the mechanical properties of different CFRP. The flexural test specimens were cut into the size of 2.5 mm by 15 mm by 150 mm for measurements of elastic modulus and flexural strength. The span length between two supports was 127 mm. The crosshead velocity was 6.0 mm/min. The displacement at the loading point was measured by an extensometer. The short beam shear test specimens were cut into the size of 2.5 mm by 5.0 mm by 15 mm for measurements of interlaminar shear strength (ILSS) of CFRP. The span length between two supports was 10 mm. The crosshead velocity was 1.0 mm/min. A minimum of 3 specimens were used for both tests to reduce error.

### Characterizations of Bio-Based Epoxy Nanocomposites

The exfoliated clay layers in the anhydride-cured epoxy matrix were observed with transmission electron microscopy (TEM). Thin sections of approximately 100 nm were obtained at room temperature by ultramicrotomy with a diamond knife having an included angle of 4°. A JEOL 2010 TEM with field emission filament in 200 kV was used to collect bright field images of the bio-based epoxy/clay nanocomposites.

The morphology of the fracture surface of the anhydride-cured epoxy samples were observed with scanning electron microscopy (SEM). A few nanometer thick gold coating was made on the observed fracture surface of the epoxy samples. A JEOL 6300 SEM with field emission filament in 20 kV was used to collect SEM images for both neat epoxy and nanocomposites.

Dynamic mechanical properties were collected with a TA Instruments DMA 2980 operating in the three-point bending mode at an oscillation frequency of 1.0 Hz. Data were collected from ambient to 170° C. at a scanning rate of 2° C./min. The grass transition temperature, T_{g}, was assigned as the temperature where tan δ was a maximum. A minimum of 3 specimens of each composition were tested.

Thermogravimetric analysis (TGA) was conducted with a TA Instruments TGA 2950 that was fitted to a nitrogen purge gas from ambient to 1000° C. This unit has the ability to decrease the ramp rate when an increased weight loss is detected in order to obtain better temperature resolution of a decomposition event. The general ramp rate was 25° C./min with a weight loss detection sensitivity set to 4.0 corresponding to 0.316%/min in the furnace control software. The sensitivity value, which corresponds to a specific %/min weight change, is a unitless number which defines the conditions used to automatically adjust the heating rate. Approximately 5˜15 mg of powdered samples were used to determine the decomposition temperatures.

Izod impact strength was measured with 453 g (1.0 lb) pendulum for neat epoxy and bio-based epoxy/clay nanocomposites at room temperature. Izod impact specimens with the same dimension indicated in ASTM D256 were used.

X-ray diffraction spectra were obtained with a Rigaku diffraction system (CuKα radiation with λ=0.15418 nm) having a monochrometer operating at 45 kVat room temperature. The diffractogram step size was 20=0.024°, a count time of 2.88 seconds and a 20 range from 1-7°.

The compact tension (CT) specimens were prepared for fracture testing. The crack length a, the width W, and the thickness B of specimens were determined as 10 mm, 20 mm, and 5 mm, respectively, based on ASTM D 5045 standard. The crack was firstly made by a band saw and then the sharp initial crack tip was produced by a guillotine crack initiator and a fresh razor blade. The crack length was measured by optical microscopy after completing the fracture testing. The applied load was measured by a load cell whose maximum capacity is 4.44 kN (1000 pounds). The experiments were performed with a crosshead velocity of 15 mm/min to load the CT specimens. Displacement at the loading point was calculated from the crosshead travel. The fracture toughness was measured with at least 3 specimens for each different nanocomposite material at room temperature.

### Characterizations of CFRP and CBFRP

Flexural tests were conducted to understand the mechanical properties of different CFRP and CBFRP. The flexural test specimens were cut into the size of 2.5 mm by 15 mm by 150 mm for measurements of elastic modulus and flexural strength. The span length between two supports was 127 mm. The crosshead velocity was 6.0 mm/min. The displacement at the loading point was measured by an extensometer. A minimum of 3 specimens were used for both tests to reduce error.

Short beam shear tests were conducted to understand the interlaminar properties of 4 different CFRP. The short beam shear test specimens were cut into the size of 2.5 mm by 5.0 mm by 15 mm for measurements of interlaminar shear strength (ILSS), based on ASTM D 2344 standard. The span length between two supports was 10 mm. The crosshead velocity was 1.0 mm/min. A minimum of 3 specimens were used for both tests to reduce error. Morphology of clay platelets in bio-based epoxy matrix

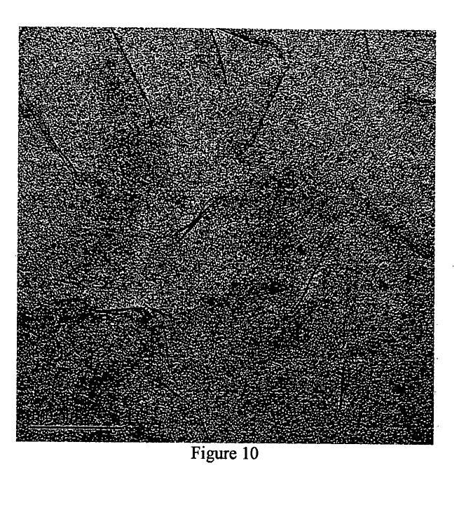

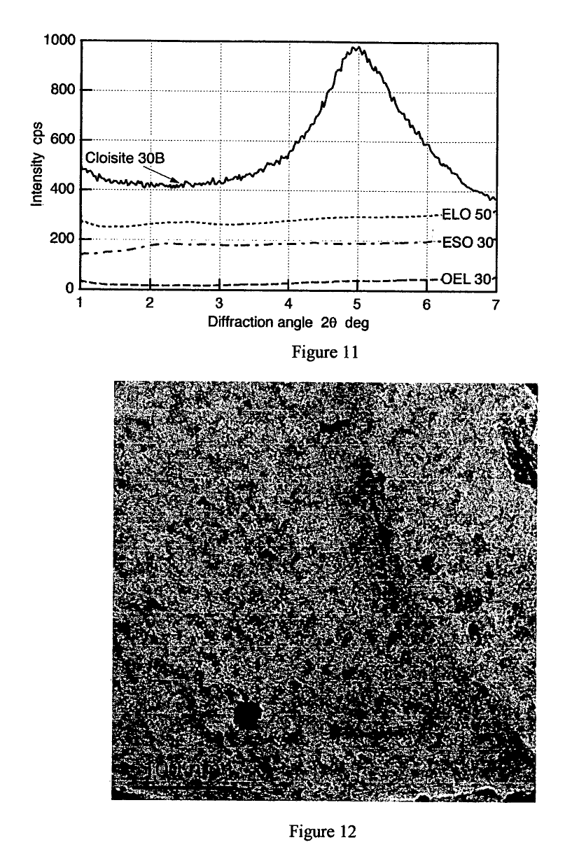

FIGS. 9 and 10 show the low and high magnification micrographs observed by transmission microscopy (TEM). In FIG. 9, we have found that the excellent homogeneous dispersion of clay platelets was achieved due to the clay modification with MT2EtOH and sonication. In FIG. 10, the TEM micrograph shows that almost all clay platelets were delaminated and the disordered and perfect exfoliation was achieved. FIG. 11 shows the WAXS patterns at low diffraction angles for organo-montmorillonite clay particles and several anhydride-cured bio-epoxy/clay nanocomposites prepared with the solution technique. The [001] diffraction of clay layers appeared at 2θ=5.01°; therefore, the basal spacing of clay was determined to be 1.76 nm. On the other hand, no clear XRD peak for bio-epoxy/clay nanocomposites was observed. Therefore, we could conclude from both TEM micrographs and WAXS data that clay platelets were completely exfoliated. These excellent dispersion and exfoliation result in the higher elastic modulus.

### Morphology of Alumina Nanowhiskers in Anhydride-Cured Bio-epoxy Matrix

FIG. 12 shows the low magnification micrograph of aluina nanowhiskers/bio-epoxy nanocomposites observed by TEM. In FIG. 12, we have also found that the excellent homogeneous dispersion of alumina nanowhiskers was obtained because of surface treatment and sonication. However, it was difficult to observe each individual alumina nanowhiskers in bio-epoxy matrix, since alumina nanowhiskers were randomly oriented, thus quite few nanowhiskers were along the TEM thin sections prepared by ultramicrotomy.

It should be noted that few alumina nanowhiskers tended to be settled down during the curing process because of its high density even though the surface treatment was applied. It can be thought that this can be improved with changing the curing process to obtain gel time much faster. The nano-inclusions cannot be settled down after the epoxy matrix reaches the gel condition.

### Morphology of VGCF in Anhydride-Cured Bio-epoxy Matrix

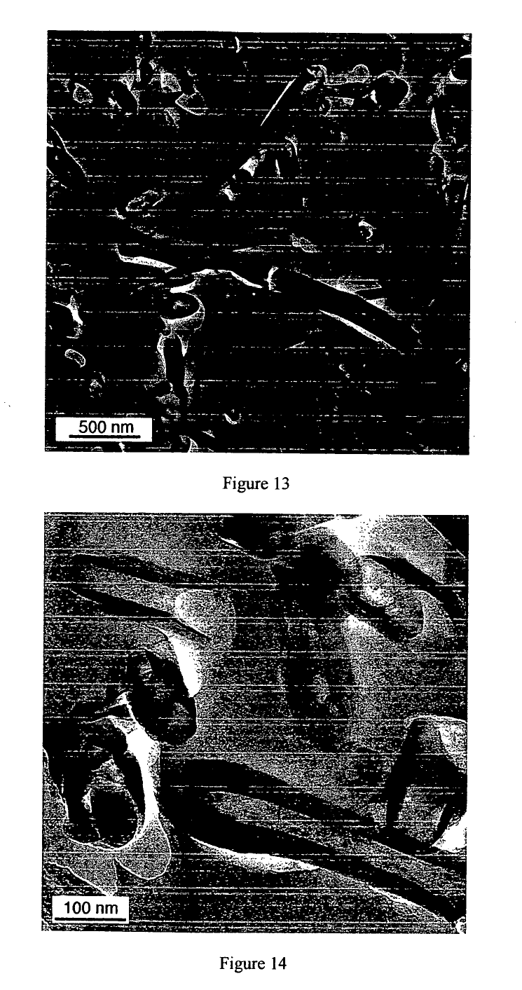

FIGS. 13 and 14 show low and high magnification TEM micrographs of VGCF/bio-epoxy nanocomposites. In FIG. 13, we have also found that the perfectly uniform dispersion of VGCF was obtained thanks to sonication in acetone. Actually, due to the excellent dispersion and high aspect ratio of VGCF, it was extremely difficult to process 5.0 wt. % VGCF/epoxy nanocomposites due to the high viscosity after removing acetone. The direction of VGCF was seldom parallel to the thin section, since the VGCF was randomly oriented in the bio-epoxy matrix. Therefore, the length of VGCF in epoxy matrix could not be accurately measured using these TEM images. However, in this image, the length of VGCF was at most 2.24 micron for reference. In FIG. 13, several cross sections of VGCF were clearly observed. The diameter of VGCF was measured in the range of 86.2-172 nm in FIG. 14.

### Thermophysical Properties of Anhydride-Cured Neat Bio-Based Epoxy

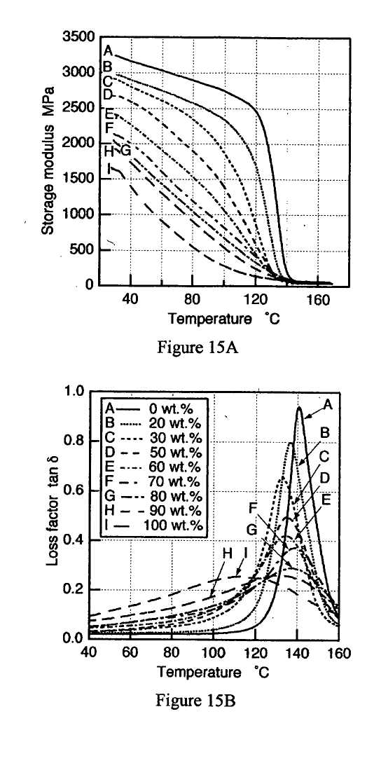

FIG. 15 shows the temperature dependency curve of storage modulus and loss factor of anhydride-cured epoxy containing ELO. In FIG. 15(a), the storage modulus below the glass transition temperature decreased with increasing the amount of ELO. The storage modulus measured by DMA is the elastic parameter of the visco-elastic properties of measured samples. Therefore, the storage modulus is theoretically the same as the elastic modulus. The storage modulus measured by DMA was found to be a true estimator of the elastic modulus that was measured by mechanical testing. In FIG. 15(b), the symmetric shape of the loss factor curve is indicative of the complete cure of the epoxy matrix. The peak position of the loss factor curves are approximately 130-140 deg C. when up to 80 wt.-% DGEBF was replaced by ELO, although the loss factor peak became broader with the addition of larger amount of ELO. In other words, no clear peak shift was observed in the range of ELO amount. On the other hand, the larger peak shift of the loss factor curve was observed when more than 90 wt.-% DGEBF was replaced by ELO. Thermophysical properties of anhydride-cured bio-based epoxy/clay nanocomposites

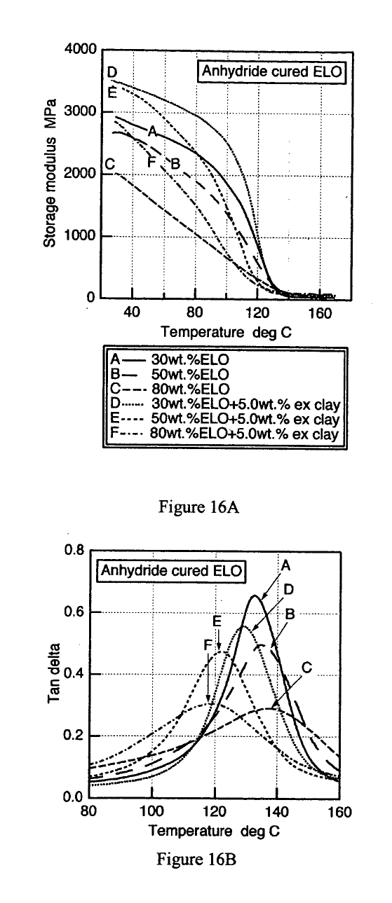

FIGS. 16A and 16B show the temperature dependency curve of storage modulus and loss factor of anhydride-cured epoxy nanocomposites containing ELO and 5.0 wt % exfoliated clay nanoplatelets. In FIG. 16A, the storage modulus below the glass transition temperature decreased with the addition of exfoliated clay nanoplatelets. In FIG. 16B, the symmetric shape of the loss factor curve is indicative of the complete cure of the epoxy matrix. The peak position of the loss factor curves was decreased approximately −10 deg C. with the addition of 5.0 wt % exfoliated clay.

Table 1 Change of storage modulus of anhydride-cured epoxy with different functionalized vegetable oils and their nanocomposites at 30° C. measured by DMA.

Table 1 shows the change of the storage modulus at 30° C. of both neat different bio-based epoxy and their nanocomposites reinforced by different nano inclusions. First, we have prepared the anhydride- and amine-cured neat epoxy samples with changing the ratio of biobased epoxidized oils. Second, the anhydride-cured clay nanocomposites composed of anhydride-cured bisphenyl-F epoxy resin modified with ELO, ESO, OEL, or ASO have been prepared. Third, a novel sample preparation scheme was used to process the modified clay in the glassy bio-based epoxy network resulting in nanocomposites where the clay was exfoliated by the epoxy network. The storage modulus of 5.0 wt. % clay nanocomposites at room temperature, which was below the glass transition temperature of the bio-based epoxy/clay nanocomposites, showed approximately 0.8 GPa higher than that of original bio-based neat epoxy which represents the increase of up to 40%.

TABLE 1

| DGEBA, | | | | | | | |
|---|---|---|---|---|---|---|---|
| wt. % | DGEBF, wt. % | Bio, wt. % | Neat | 5.0 wt. % Clay | 5.0 wt. % Alumina | 4.0 wt. % VGCF | 0.2 wt. % SWCNT |
| 100 | 0 | 0 | 3.17 +/− 0.18 | 3.92 +/− 0.09 | | | |
| 100 | 0 | 0 | 3.10 +/− 0.13 | 3.90 +/− 0.06 | | | |
| | | | (tensile) | (tensile) | | | |
| 0 | 100 | 0 | 3.21 +/− 0.09 | | 4.59 +/− 0.09 | 3.91 +/− 0.15 | 4.04 +/− 0.07 |
| 0 | 80 | ELO20 | 3.01 +/− 0.15 | | | | |
| 0 | 70 | ELO 30 | 2.77 +/− 0.13 | 3.50 +/− 0.10 | | | |
| 0 | 50 | ELO 50 | 2.63 +/− 0.11 | 3.41 +/− 0.13 | 3.93 +/− 0.17 | 3.38 +/− 0.28 | 3.30 +/− 0.15 |
| 0 | 40 | ELO 60 | 2.40 +/− 0.20 | | | | |
| 0 | 30 | ELO 70 | 2.10 +/− 0.05 | | | | |
| 0 | 20 | ELO 80 | 2.08 +/− 0.12 | 2.80 +/− 0.05 | | | |
| 0 | 10 | ELO 90 | 1.92 +/− 0.09 | | | | |
| 0 | 0 | ELO 100 | 1.70 +/− 0.14 | | | | |
| 0 | 80 | ESO 20 | 2.98 +/− 0.04 | | | | |
| 0 | 70 | ESO 30 | 2.61 +/− 0.09 | 3.61 +/− 0.12 | | | |
| 0 | 60 | ESO 40 | 2.31 +/− 0.12 | | | | |
| 0 | 50 | ESO 50 | 1.78 +/− 0.12 | | | | |
| 0 | 30 | ESO 70 | 1.19 +/− 0.03 | 2.05 +/− 0.13 | | | |
| 0 | 80 | OEL 20 | 3.17 +/− 0.14 | 3.95 +/− 0.04 | | | |
| 0 | 70 | OEL 30 | 2.95 +/− 0.15 | 3.86 +/− 0.26 | | | |
| 0 | 50 | OEL 50 | 2.37 +/− 0.06 | 3.06 +/− 0.14 | | | |
| 0 | 20 | OEL 80 | 1.01 +/− 0.20 | 1.63 +/− 0.21 | | | |
| 0 | 70 | ASO 30 | 3.16 +/− 0.14 | | | | |
| 0 | 50 | ASO 50 | 2.42 +/− 0.21 | | | | |
| 0 | 30 | ASO 70 | 0.931 +/− 0.217 | | | | |

Table 2 change of glass transition temperature of anhyhdride-cured neat epoxy and their nanocomposites with increasing different functionlized vegetable oils.

Table 2 shows the change of glass transition temperature determined from the peak position of tan delta curve measured by DMA, regarding the change of the amount of different functionalized vegetable oils for anhydride-cured neat epoxy and its clay nanocomposites. The sample of anhydride-cured 100% ELO showed the lowest T_{g}, which was still 110° C. For other vegetable oils, T_{g} seemed to linearly decrease with increasing the amount of each functionalized vegetable oil. Like anhydride-cured petroleum-based epoxy/clay nanocomposites, which was previously studied by some of the inventors, the glass transition temperature decreased because of the quaternary ammonium ion used for clay modification. The quaternary ammonium ion reacted as an accelerator and this resulted in the different cross-link density of epoxy matrix. Therefore, T_{g} was decreased even if the stoichiometry was still achieved.

TABLE 2

| DGEBF, wt. % | Bio, wt. % | Neat | 5.0 wt. % Clay | 5.0 wt. % Alumina | 4.0 wt. % VGCF | 0.2 wt. % SWCNT |
|---|---|---|---|---|---|---|
| 100 | 0 | 140 +/− 0 | | 130 +/− 3 | 131 +/− 1 | 105 +/− 1 |
| 80 | ELO20 | 136 +/− 0 | | | | |
| 70 | ELO 30 | 133 +/− 1 | 124 +/− 4 | | | |
| 50 | ELO 50 | 134 +/− 1 | 120 +/− 3 | 114 +/− 2 | 118 +/− 11 | 93.5 +/− 1.7 |
| 40 | ELO 60 | 136 +/− 2 | | | | |
| 30 | ELO 70 | 138 +/− 1 | | | | |
| 20 | ELO 80 | 135 +/− 2 | 117 +/− 4 | | | |
| 10 | ELO 90 | 129 +/− 2 | | | | |
| 0 | ELO 100 | 116 +/− 5 | | | | |
| 80 | ESO 20 | 131 +/− 0 | | | | |
| 70 | ESO 30 | 132 +/− 1 | 117 +/− 1 | | | |
| 60 | ESO 40 | 125 +/− 1 | | | | |
| 50 | ESO 50 | 116 +/− 3 | | | | |
| 30 | ESO 70 | 115 +/− 4 | 87.2 +/− 2.0 | | | |
| 80 | OEL 20 | 120 +/− 1 | 114 +/− 1 | | | |
| 70 | OEL 30 | 115 +/− 0 | 102 +/− 1 | | | |
| 50 | OEL 50 | 106 +/− 1 | 91.4 +/− 0.9 | | | |
| 20 | OEL 80 | 83.9 +/− 5.5 | 69.6 +/− 0.5 | | | |
| 70 | ASO 30 | 103 +/− 1 | | | | |
| 50 | ASO 50 | 82.9 +/− 2.1 | | | | |
| 20 | ASO 80 | 57.2 +/− 3.1 | | | | |

### Thermophysical Properties of Anhydride-Cured Bio-Epoxy/alumina Nanowhiskers

The same sample preparation scheme was used to process the surface treated alumina nanowhiskers in the glassy bio-based epoxy network resulting in nanocomposites where the alumina nanowhiskers was homogeneously dispersed by the epoxy network. Table 1 also shows the storage modulus of neat epoxy with or without 50 wt. % ELO and their 5.0 wt. % surface treated alumina nanowhiskers nanocomposites (Argonide Corporation, NanoCeran™ fibers) at 30 deg C. Obviously, the storage modulus at room temperature, which was below the glass transition temperature of the bio-based epoxy/alumina nanowhiskers nanocomposites, radically increased almost 50% with the addition of 5.0 wt. % of alumina nanowhiskers. The larger increasing rate comparing clay is because of excellent dispersion, high aspect ratio, and the higher elastic modulus of alumina nanowhiskers. In fact, it seems that the improvement of the storage modulus with alumina nanowhiskers in the same amount is better than that with organo-clay nanoplatelets.

Table 2 also shows the change of the glass transition temperature determined from the peak position of tan delta curve for anhydride-cured epoxy nanocomposites reinforced by 5.0 wt. % surface treated alumina nanowhiskers. The glass transition temperature of ELO50/alumina nanowhisker nanocomposites was 114° C.

### Thermophysical Properties of Anhydride-Cured Bio-Epoxy/VGCF Nanocomposites

The same sample preparation scheme was used to VGCF in the glassy bio-based epoxy network resulting in nanocomposites where the VGCF was also homogeneously dispersed by the epoxy network. Table 1 also shows the storage modulus of neat epoxy with or without 50 wt. % ELO and their 4.0 wt. % VGCF nanocomposites (Applied Science, PR-19-PS) at 30 deg C. It was extremely difficult to process 5.0 wt. % VGCF nanocomposites, because of the high viscosity of main epoxy components after removing solvent in the same sonication process. Obviously, the storage modulus at room temperature, which was below the glass transition temperature of the bio-based epoxy/clay nanocomposites, increased approximately 0.8 GPa, which represents the improvement of up to 30% with the addition of 4.0 wt. % VGCF. Therefore, the improvement of storage modulus with 4.0 wt. % VGCF was similar to that with 5.0 wt. % exfoliated clay platelets. As observed in FIG. 13, the aspect ratio of VGCF might be smaller than that of exfoliated clay. However, the modulus of VGCF is reported as 500 GPa, which is much larger than that of clay. Therefore, it is possible to expect as good an improvement of storage modulus as with exfoliated clay. Table 2 also shows the change of the glass transition temperature determined from the peak position of tan delta curve for anhydride-cured epoxy nanocomposites reinforced by 4.0 wt. % VGCF. The glass transition temperature of ELO50/VGCF nanocomposites was 118° C.

### Thermophysical Properties of Anhydride-Cured Bio-Epoxy/SWCNT Nanocomposites

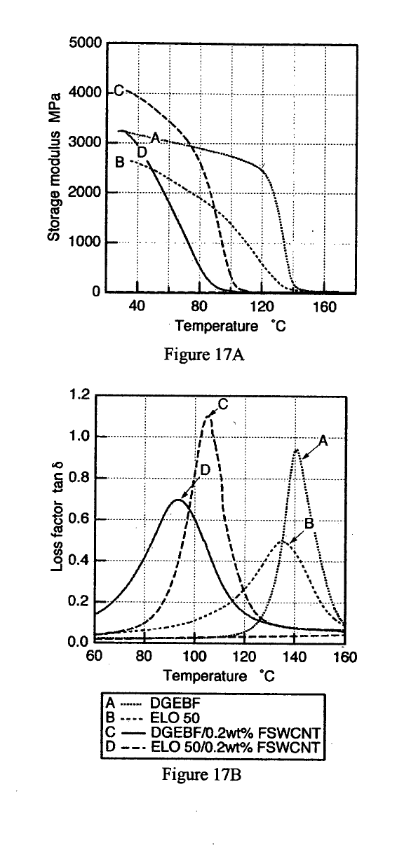

The same sample preparation scheme was used to process the fluorinated SWCNT in the glassy bio-based epoxy network resulting in excellent nanocomposites. FIG. 17 illustrates the results of the DMA testing of the anhydride-cured epoxy/FSWCNT nanocomposites. In this Figure, ELO 50 stands for 50 wt % of DGEBF replaced by the same weight of ELO. The MTHPA is employed stoichiometrically with the DGEBF epoxy and the mixture of DGEBF (50 wt %)/ELO (50 wt %) at 92.7 phr and 91.6 phr, respectively. This amount of MTHPA was not adjusted with the addition of FSWCNT in this Figure. The storage modulus of the epoxies at 30° C. increased by 0.66 to 0.83 GPa with the addition of only 0.2 wt % (0.14 vol %) of FSWCNT, as shown in FIG. 17(a) and Table 1, representing an approximate 25% improvement. This suggests that individual FSWCNT were well separated because of the fluorination of the SWCNT and, as a result, they were homogeneously dispersed in the epoxy matrix. Other reasons for the increase of the storage modulus are discussed further and supported by the following Figures.

The symmetric peak of the loss factor, tan δ, in FIG. 17(b), indicates the complete cure of the anhydride-cured epoxy matrix. The glass transition temperature, T_{g}, was assigned as the temperature at peak maximum of tan δ as shown in FIG. 17(a). The T_{g} clearly decreased with ˜30 to 35° C. with the addition of 0.2 wt % FSWCNT. A large decrease in glass transition temperature has not been observed with other nanocomposites reinforced by organo-clay nanoplatelets, silica nanoparticles, and vapor grown carbon fibers. The large reduction of the glass transition temperature when using FSWCNT reinforcement may be due to the absorption of DGEBF into the FSWCNT, which has much larger surface area than any other nano-inclusions, because the sonicated FSWCNT were first mixed with DGEBF before adding the anhydride curing agent. As a result, the surface of SWCNT was coated by the DGEBF, causing a non-stoichiometric mixture and a decrease of the glass transition temperature. Table 2 also shows the change of tan delta curve of neat epoxy with or without 50 wt. % ELO and their 0.2 wt. % fluorinated SWCNT. The glass transition temperature of ELO50/SWCNT nanocomposites was 93.5° C.

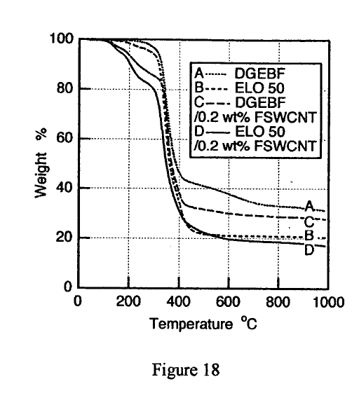

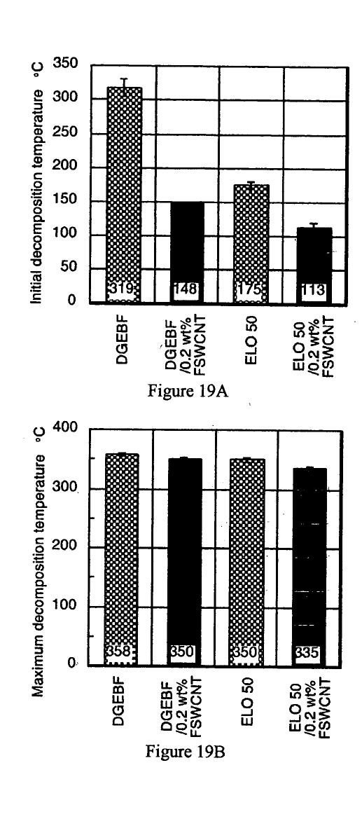

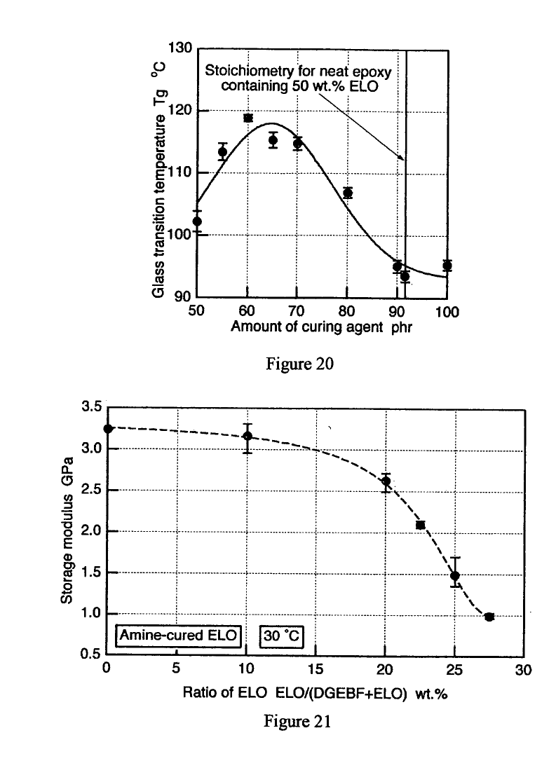

The non-stoichioimetry was also observed by TGA. FIG. 18 shows the typical TGA weight loss obtained in a nitrogen atmosphere for the neat epoxies and their 0.2 wt. % FSWCNT nanocomposites. The major difference between the neat epoxies and the FSWCNT composites was observed in the temperature range of 100-300° C. The weight loss for the neat epoxies was extremely small, although the decomposition of the FSWCNT nano-composites had definitely started. As shown in FIG. 19A, the initial decomposition temperature of the neat epoxies and their FSWCNT nanocomposites were measured from FIG. 18. In FIG. 19A, the initial decomposition temperature clearly became lower with the addition of SWCNT for both DGEBF and biobased ELO epoxy systems. The reduction of the initial decomposition temperature is indicative of the existence of unreacted constituents. In addition, the maximum decomposition temperature, as shown in FIG. 19B, was also reduced after adding 0.2 wt % FSWCNT to both epoxies. Generally, thermoset polymers having higher cross-link density show higher maximum decomposition temperature. The cross-link density is maximized when the stoichiometry of epoxy is maintained. Hence, when the stoichiometry of the epoxy matrix was broken with an addition of 0.2 wt % SWCNT, as illustrated in FIGS. 18 and 19A, the cross-link density possibly was reduced and this fact resulted in lower decomposition temperature, as observed in FIG. 19B. To experimentally investigate the proper amount of the anhydride curing agent required to maintain the stoichiometry of the epoxy matrix, the amount of the anhydride curing agent was changed between 50˜100 phr, and the change of the glass transition temperature by fixing the weight ratio between DGEBF, ELO, accelerator, and FSWCNT was observed. In this case, the weight content of FSWCNT became larger with decreasing the amount of the anhydride curing agent. The glass transition temperature was maximized when the stoichiometry was achieved in the epoxy matrix. FIG. 20 shows the relation between the amount of the anhydride curing agent and the glass transition temperature. The symbols and the solid line in this Figure show the average experimental values and their least-square fit line of the Gaussian curve. The peak of the Gaussian fit line was approximately 65 phr. Therefore, this Figure shows that the stoichiometry of the epoxy matrix was achieved when 26 phr anhydride curing agent was omitted. This amount of the reduced anhydride-curing agent was too large to be absorbed by SWCNT having high surface area. In addition, it should be noted that the glass transition temperature of the 0.2 wt % FSWCNT nanocomposites was still reduced from that of the neat epoxy. One of the explanations of the above results is that the fluorination is useful in disrupting the van der Waals forces between SWCNT, but fluorine can easily become free radicals at higher temperature and might have break the chains including epoxide rings of both DGEBF and ELO. As a result, the lower molecular weight and the smaller number of epoxide rings of shortened DGEBF and ELO structures resulted in lower cross-link density, which was observed as lower maximum decomposition temperature (FIG. 19B), and lower glass transition temperature (FIG. 20).

### Thermophysical Properties of Amine-Cured Neat Epoxy with ELO

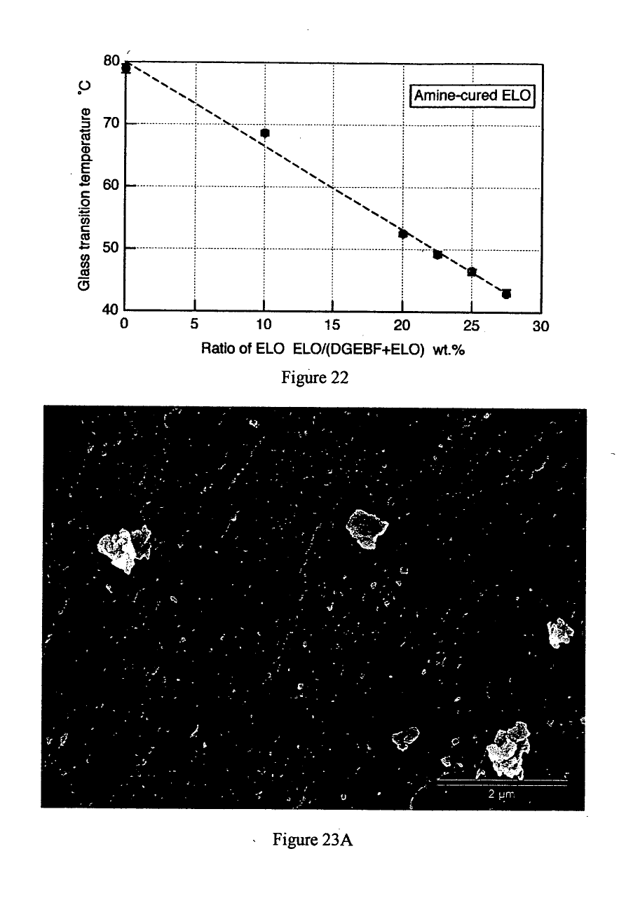

FIG. 21 shows the relation between the storage modulus at 30° C. measured by DMA and the amount of ELO for amine-cured neat epoxy. It seems that the storage modulus of neat epoxy decreased with increasing the amount of ELO. This reduction of the storage modulus is also discussed with FIG. 22. FIG. 22 shows the relation between the glass transition temperature determined from the peak position of tan delta curve and the amount of ELO for amine-cured neat epoxy and its clay nanocomposites. Glass transition temperature was obviously decreased with increasing the ratio of ELO, and the T_{g} of the system including 27.5 wt. % was extremely close to the room temperature. As expected, the relation between the glass transition temperature and the amount of ELO was linearly correlated. Because of the glass transition temperature which is extremely close to the room temperature with more than 20 wt. % ELO, the storage modulus also dramatically decreased with increasing the amount of ELO as shown in FIG. 21.

### Heat Distortion Temperature of Anhydride-Cured Neat Epoxy and its Clay Nanocomposites

Table 3 change of heat distortion temperature (HDT) of anhydride-cured neat epoxy with vegetable oils before and after adding different nano-reinforcements.

The heat distortion temperature (HDT) of anhydride-cured neat epoxy and their different nanocomposites was also measured with DMA. Table 3 shows the change of HDT with respect to the amount of different vegetable oil before and after adding nano-reinforcements. HDT values remain comparatively higher even after the addition of 80 wt. % of ELO and 5.0 wt. % exfoliated organo-clay nanoplatelets. For the automotive and aeronautical applications, the minimum of 100° C. as HDT is required. Therefore, it could be thought that the maximum of 50 wt. % ELO or 30 wt. % ESO/OEL is suitable to process nanocomposites to maintain high HDT value. We did not process any nanocomposites with ASO, because of the low HDT value and its high viscosity of ASO component.

TABLE 3

| DGEBF, | | | | 4.0 wt. % |
|---|---|---|---|---|
| wt. % | Bio, wt. % | Neat | 5.0 wt. % Clay | VGCF |
| 100 | 0 | 132 +/− 0 | | 125 +/− 2 |
| 70 | ELO 30 | 121 +/− 2 | 109 +/− 3 | |
| 50 | ELO 50 | 115 +/− 1 | 112 +/− 3 | 110 +/− 14 |
| 20 | ELO 80 | 112 +/− 6 | 102 +/− 3 | |
| 70 | ESO 30 | 117 +/− 1 | 104 +/− 1 | |
| 50 | ESO 50 | 90.5 +/− 3.0 | | |
| 30 | ESO 70 | 77.2 +/− 4.7 | 65.9 +/− 2.4 | |
| 80 | OEL 20 | 109 +/− 2 | 103 +/− 1 | |
| 70 | OEL 30 | 102 +/− 0 | 88.2 +/− 4.6 | |
| 50 | OEL 50 | 87.3 +/− 1.6 | 72.8 +/− 7.6 | |
| 20 | OEL 80 | 55.2 +/− 0.5 | 50.8 +/− 0.8 | |

### Izod Impact Strength of Anhydride-Cured Neat Epoxy and Different Nanocomposites

Table 4 change of Izod impact strength of anhydride-cured neat epoxy with different vegetable oils and their nanocomposites.

Table 4 shows the change of Izod impact strength of anhydride-cured neat epoxy with different amount of functionalized vegetable oil before and after adding different nano reinforcements. The anhydride-cured rigid epoxy sample has a high cross link density; therefore, the value of the Izod impact strength was relatively low. Comparing the DGEBF with the biobased neat epoxy containing 50 wt. % ELO, the Izod impact strength was almost the same. For a rigid epoxy system, it was reported that it is difficult to maintain the same value of Izod impact strength and that the impact strength was independent from the clay morphology. Although no clear difference was observed between intercalated and exfoliated clay/ELO nanocomposites in Table 4, the Izod impact strength could be maintained after the exfoliated clay nanoplatelets were added to the ELO epoxy system.

TABLE 4

| DGEBF, wt. % | Bio, wt. % | Neat | 5.0 wt. % Clay | 5.0 wt. % Alumina | 4.0 wt. % VGCF | 0.2 wt. % SWCNT |
|---|---|---|---|---|---|---|
| 100 | 0 | 18.6 +/− 3.2 | | 14.8 +/− 0.3 | 15.0 +/− 0.9 | 20.8 +/− 6.3 |
| 80 | ELO20 | 16.5 +/− 2.5 | | | | |
| 70 | ELO 30 | 16.4 +/− 5.9 | 16.6 +/− 2.0 | | | |
| 50 | ELO 50 | 20.5 +/− 4.7 | 19.8 +/− 3.9 | 15.8 +/− 1.6 | 16.0 +/− 2.8 | 16.4 +/− 0.7 |
| 40 | ELO 60 | 19.8 +/− 3.2 | | | | |
| 30 | ELO 70 | 12.0 +/− 2.9 | | | | |
| 20 | ELO 80 | 15.2 +/− 0.6 | 18.2 +/− 3.9 | | | |
| 10 | ELO 90 | 12.6 +/− 1.9 | | | | |
| 80 | ESO 20 | 20.5 +/− 4.4 | | | | |
| 70 | ESO 30 | 22.3 +/− 0.9 | 15.9 +/− 4.4 | | | |
| 60 | ESO 40 | 22.4 +/− 2.8 | | | | |
| 50 | ESO 50 | 10.9 +/− 0.3 | | | | |
| 30 | ESO 70 | 13.8 +/− 1.6 | 20.7 +/− 3.1 | | | |
| 80 | OEL 20 | 15.9 +/− 3.0 | 15.8 +/− 1.1 | | | |
| 70 | OEL 30 | 16.3 +/− 3.0 | 15.3 +/− 1.2 | | | |
| 50 | OEL 50 | 15.8 +/− 0.8 | 16.7 +/− 0.7 | | | |
| 20 | OEL 80 | 12.0 +/− 0.5 | 13.4 +/− 0.5 | | | |

On the other hand, the Izod impact strength was improved more than 25% when 30 wt % of DGEBF was replaced by ESO. However, the Izod impact strength decreased after adding 5.0 wt. % exfoliated and intercalated clay nanoplatelets, and the values became almost the same as those of DGEBF, ELO neat epoxy, and its different nanocomposites.

The Izod impact strength decreased after adding 4.0 wt. % VGCF and 5.0 wt. % alumina nanowhiskers. There is a trade-off problem with different nanocomposites; clay platelets provide excellent improvement of mechanical properties, alumina nanowhiskers provide better improvement of modulus, and VGCF provide electrical conductivity.

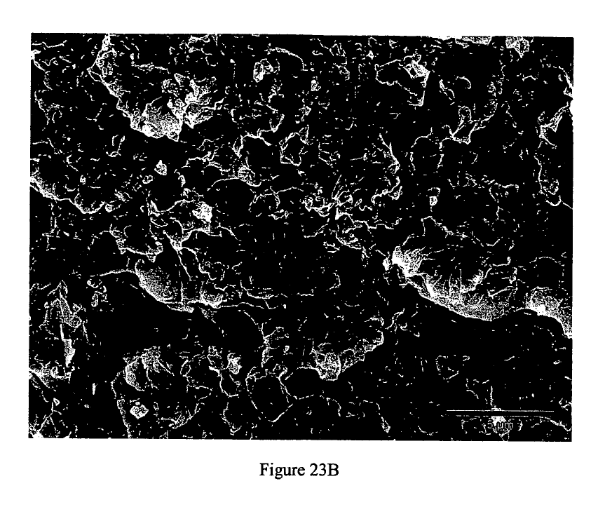

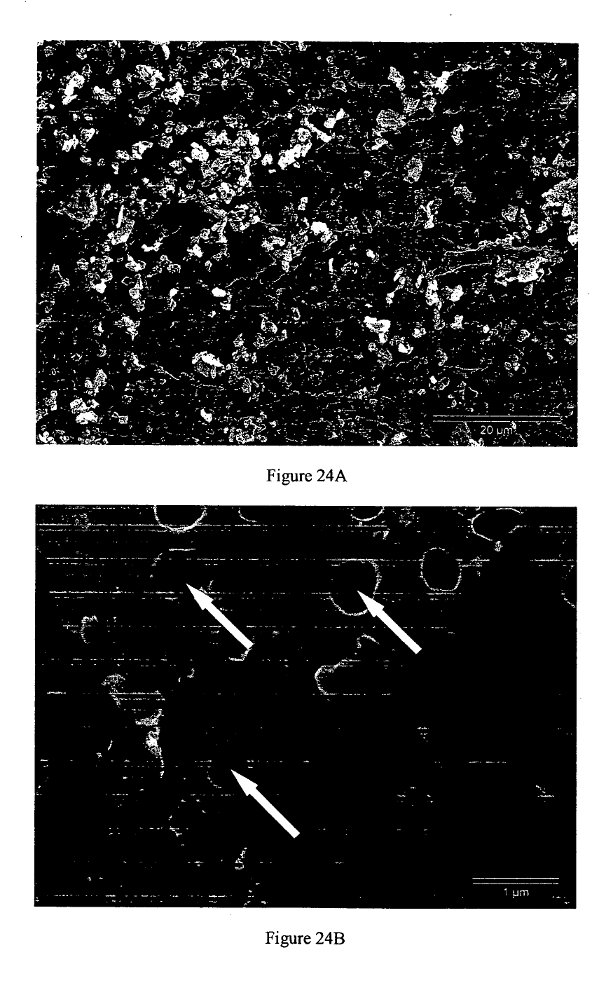

To investigate the difference of the Izod impact strength of the anhydride-cured biobased epoxies, it is necessary to observe the morphology of the impact failure surfaces by SEM. FIG. 23A shows SEM micrographs of the impact failure surfaces of the anhydride-cured biobased epoxy materials and their clay nanocomposites. In FIG. 23A, the failure surface of the anhydride-cured ELO neat epoxy was generally flat and featureless. The similar morphology was observed for anhydride-cured DGEBF. This suggests that the behavior of the anhydride-cured ELO neat epoxy was elastic and the crack propagated in a planar manner under impact loading, although several small pieces of resin were found on the failure surface. In addition, it can be concluded that DGEBF, ELO, and MTHPA were homogeneously mixed and then cured. In FIG. 23B, the failure surface of biobased epoxy nanocomposites, containing 50 wt. % ELO and reinforced by 5.0 wt. % exfoliated clay nanoplatelets, showed the rougher surface, because of the existence of exfoliated clay nanoplatelets in the ELO epoxy matrix.

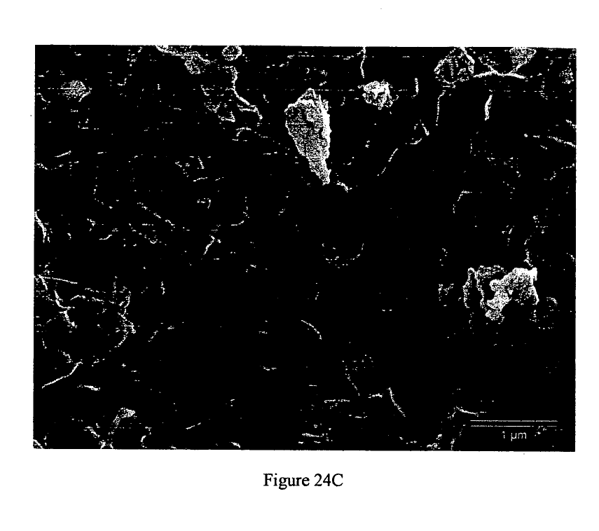

In contrast, the failure surface of the anhydride-cured biobased neat epoxy containing 30 wt. % ESO was much rougher, and a larger number of the small resin pieces were found on the failure surface in FIG. 24A. FIG. 24B is a higher magnification SEM micrograph of the same failure surface of the anhydride-cured biobased neat epoxy containing 30 wt. % ESO. The regions, indicated with arrows in FIG. 24B, are ESO-rich rubber phases. The presence of a second phase is clearly evident in FIG. 24B. The anhydride-cured biobased neat epoxy containing 30 wt. % ESO was not transparent, although the anhydride-cured DGEBF and biobased neat epoxy containing 50 wt. % ELO were transparent. In other words, the lack of the transparency was the result of the phase separation. ELO has higher epoxy functionality and lower molecular weight than ESO. Consequently, ELO has higher polarity than ESO, and hence, ELO has better solubility and compatibility with polar DGEBF, while ESO has larger possibility to create phase separation than ELO. The size of the ESO-rich rubber phase was measured to be d=250˜650 nm in FIG. 24B. The void-like feature of the ESO-rich rubber phases was created by distortional pullout of the rubbery particles under the impact loading. A much greater energy is dissipated to pull out rubber phases. Therefore, the anhydride-cured ESO neat epoxy having the phase separation showed more than 25% higher Izod impact strength. The DGEBF and ELO neat epoxy that did not have any phase separation and exhibited a lower impact strength. In FIG. 24C, the failure surface of biobased epoxy nanocomposites, containing 30 wt. % ESO and reinforced by 5.0 wt. % exfoliated clay nanoplatelets, showed the rougher surface whose morphological feature was extremely similar to that shown in FIG. 23B, because of the existence of exfoliated clay nanoplatelets in the ELO epoxy matrix. In FIG. 24C, no phase separation was observed on the impact failure surface after adding exfoliated and intercalated clay nanoplatelets into ESO epoxy system. In fact, the non-transparent ESO epoxy became transparent after adding clay nanoplatelets. Because of the lack of the phase separation after adding clay nanoplatelets, the Izod impact strength of the anhydride-cured ESO epoxy reinforced by clay nanoplatelets decreased as almost the same as those of DGEBF, ELO neat epoxy, and its nanocomposites. Izod impact strength of amine-cured neat epoxy

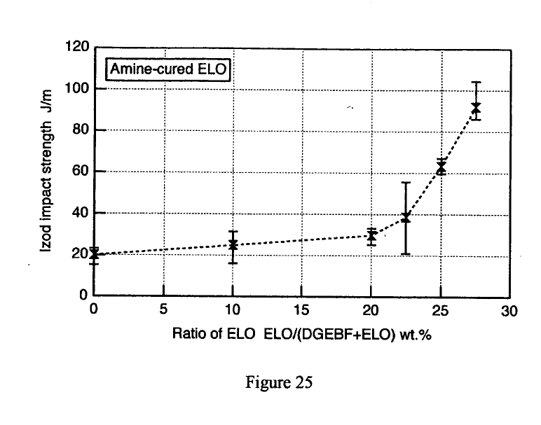

FIG. 25 shows the change of Izod impact strength of amine-cured epoxy with changing the amount of ELO. The strength was radically increased with the increase of ELO in more than 20 wt. %, since Tg became closer to the room temperature with increasing the amount of ELO.

### Fracture Toughness of Clay/epoxy Nanocomposites

The compact tension (CT) specimens were prepared for fracture testing. The crack length a, the width W, and the thickness B of specimens were determined as 10 mm, 20 mm, and 5 mm, respectively, based on ASTM D 5045 standard. The crack was firstly made by a band saw, and then the sharp initial crack tip was produced by a guillotine crack initiator and a fresh razor blade. The crack length was measured by optical microscopy after completing the fracture testing. The applied load was measured by a load cell whose maximum capacity is 4.44 kN (1000 pounds). The experiments were performed with a crosshead velocity of 15 mm/min to load the CT specimens. Displacement at the loading point was calculated from the crosshead travel. The fracture toughness was measured with at least 3 specimens for each different nanocomposite material at room temperature.

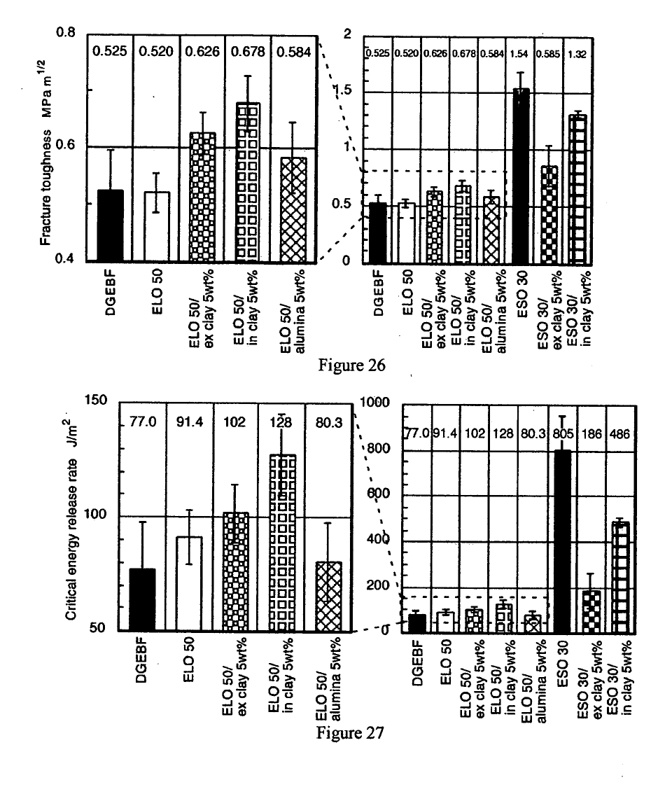

The non-linearity was seldom observed in load-displacement diagrams of bio-based neat epoxies and their nanocomposites. Therefore, the maximum load was used to evaluate fracture toughness. Fracture toughness can be defined with the stress distribution at the vicinity of the crack tip when the maximum loading is applied and the crack propagates. Fracture toughness is one of the mechanical properties of brittle materials, showing the linear load-displacement relation. FIG. 26 shows the fracture toughness of the DGEBF, biobased neat epoxies, and their nanocomposites. The ELO neat epoxy showed the similar value of the fracture toughness in FIG. 26. In a contrast, the ESO neat epoxy showed extremely high fracture toughness. This was a result of the presence of a second rubbery phase. This is further explained with SEM micrographs. For biobased epoxy/clay nanocomposites, the intercalated clay nanocomposites showed higher fracture toughness than the exfoliated clay nanocomposites. The size of alumina nanowhiskers is even smaller than that of exfoliated clay nanoplatelets, thus, the toughening effect of alumina nanowhiskers was minimal as seen in FIG. 26.

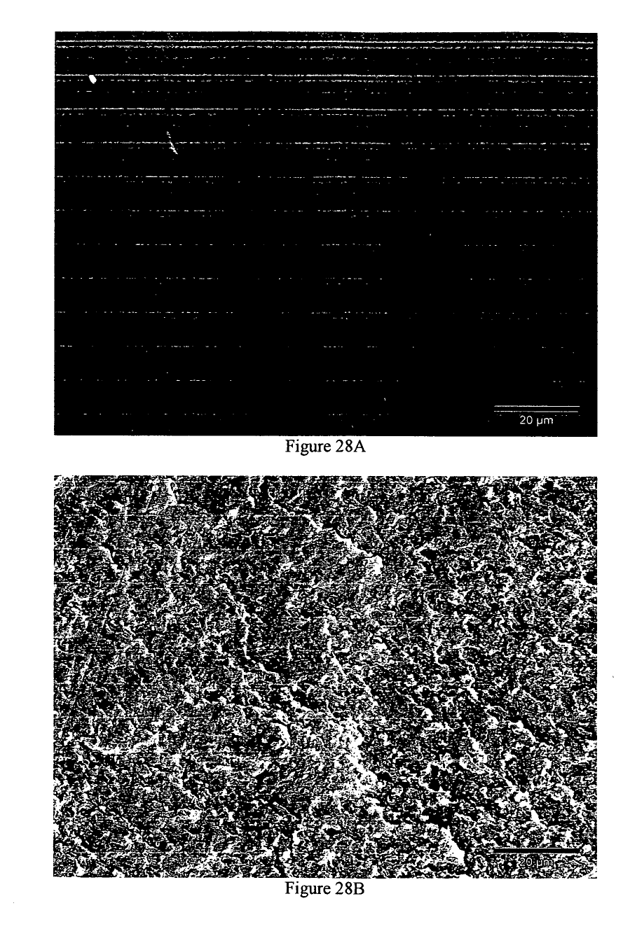

The toughening effect can also be discussed with critical energy release rate as shown in FIG. 27. The critical energy release rate represents the amount of strain energy dissipated by the member per unit area of the newly created fracture surface when the crack propagates. The critical energy release rate can be transformed from the fracture toughness with elastic constants of materials. The anhydride-cured neat ELO epoxy has slightly smaller storage modulus than the DGEBF as discussed in Table 2. Therefore, the critical energy release rate of the ELO neat epoxy was slightly higher than that of the DGEBF. In the three different anhydride-cured epoxies, the ESO neat epoxy has the largest critical energy release rate, and was more than 10 times as large as that of the DGEBF, after 30 wt. % of DGEBF was replaced by ESO. The improvement ratio of the critical energy release rate with ESO was much larger than that of the Izod impact strength, due to time-temperature superposition. Under impact conditions, a very fast loading is applied, resulting in polymer behavior similar to low temperature fracture.

After adding 5.0 wt. % intercalated clay nanoplatelets into ELO epoxy system, the critical energy release rate was greatly improved, although that after adding 5.0 wt. % exfoliated clay nanoplatelets into ELO epoxy system showed slight improvement, comparing with the ELO neat epoxy. Some authors have already studied the fracture behavior of petroleum-based epoxy nanocomposites reinforced by intercalated and exfoliated clay nanoplatelets. It was already reported that the addition of intercalated clay nanoplatelets was more effective than that of exfoliated clay nanoplatelets to improve the fracture properties. This reported tendency was also applicable to the fracture properties of ELO nanocomposites. In addition, the critical energy release rate of alumina nanocomposites rather decreased, because of the higher rigidity as discussed in Table 2 and smaller size of alumina nanowhiskers than clay.

For ESO system, the addition of clay resulted in lower critical energy release rates, although the intercalated clay/ESO nanocomposites showed higher critical energy release rate than the exfoliated clay/ESO nanocomposites. The change of the critical energy release rate with the addition of intercalated and exfoliated clay nanoplatelets is discussed with SEM observations in the next session.

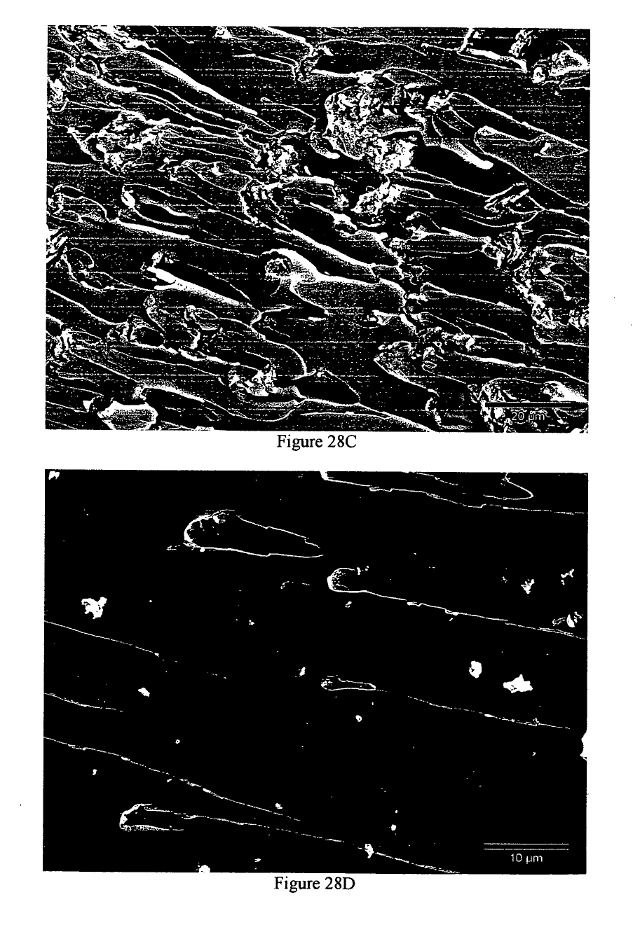

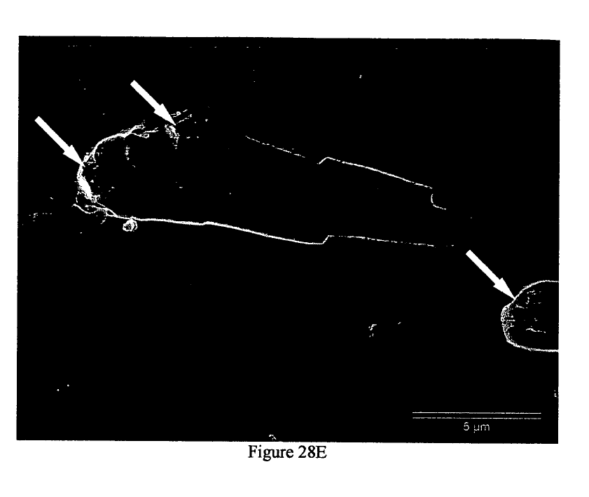

FIGS. 28A to 28C show the SEM micrographs of the fracture surfaces of the anhydride-cured ELO neat epoxy and its 5.0 wt. % exfoliated and intercalated clay nanocomposites. In FIG. 28A, the fracture surface of the ELO neat epoxy was completely flat. This suggests that the anhydride-cured ELO neat epoxy is brittle, and indeed, the load-COD diagram was almost completely elastic. Hence, the crack propagated in a planar manner and the minimal fracture surface area was created by the crack propagation. Minimal fracture surface area means minimal consumption of the energy for crack propagation. FIGS. 28B and 28C show the fracture surfaces of ELO/exfoliated clay and ELO/intercalated clay nanocomposites, respectively. The surface roughness of intercalated clay nanocomposites is obviously larger than that of exfoliated clay nanocomposites. For intercalated clay nanocomposites, the crack tends to avoid reaching the aggregations of intercalated clay particles, since the adhesion at the biobased epoxy/clay interface was excellent and the strength of clay aggregation prevents crack from propagating. Therefore, the crack tends to curve in micron order, and this results in the higher critical energy release rate with the rougher fracture surface. On the other hand, for exfoliated clay nanocomposites, it is easy to break each individual clay nanoplatelets because of the thin size as 1 nm, which is not strong enough to prevent the crack from propagating. The inclusions smaller than the size of plastic zone near the crack tip are not effective for prevention of the crack propagation. Griffith explained the fracture criteria that the crack is propagated when the strain energy reaches the certain value, which can newly create the fracture surface. In other words, when the fracture surface area is larger, larger energy is necessary for crack propagation; the critical energy release rate is larger. Consequently, the toughening effect was enormous when the clay nanoplatelets were intercalated, as the fracture surface area became larger. Indeed, the critical energy release rate was greatly improved with the intercalated clay as discussed in FIG. 27.

FIGS. 28D and 28E show the morphology of the fracture surface of ELO/alumina nanowhisker composites observed by SEM. In FIG. 28D in low magnification, the fracture surface of the alumina nanocomposites is extremely flat. The minimal fracture surface area was created for the alumina nanocomposites by the crack propagation. Hence, minimal energy was consumed for crack propagation. This result was agreed with the fact that the critical energy release rate of the alumina nanowhisker composites was lower than that of neat epoxy and exfoliated clay nanocomposites. It can be concluded that the alumina nanowhiskers do not provide toughening effect on the epoxy, although these have excellent reinforcing effects to improve the elastic modulus. In FIG. 28E in higher magnification, it was observed that the crack was slightly curved when it reached the aggregation of the alumina nanowhiskers indicated with an arrow. This morphology shows that even the aggregated alumina nanowhiskers are not as effective as that of the intercalated clay nanoplatelets.

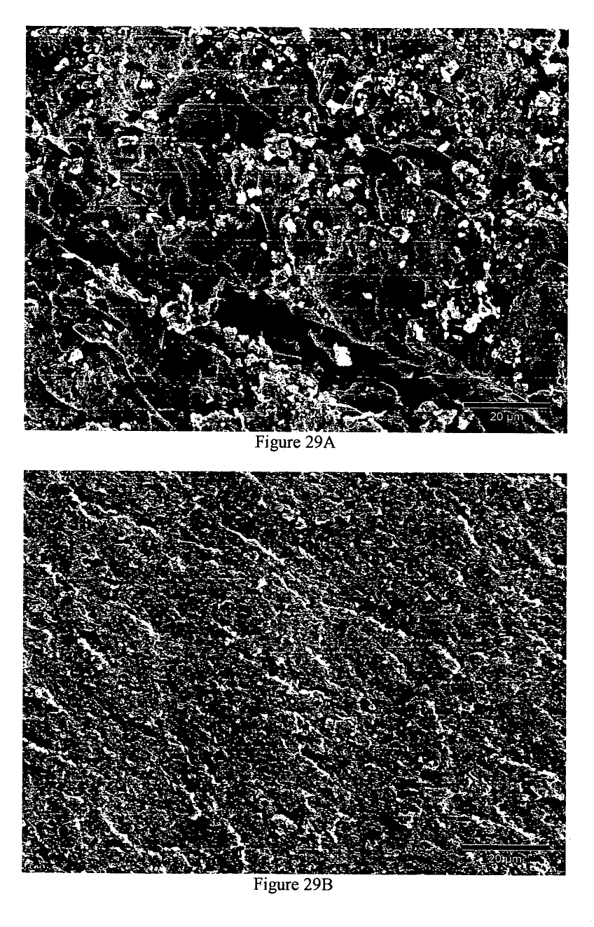

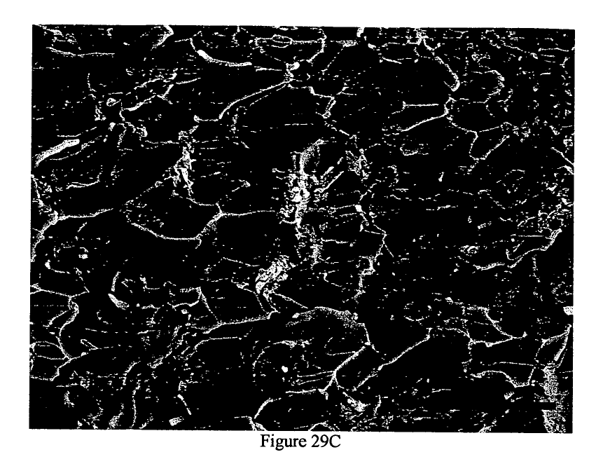

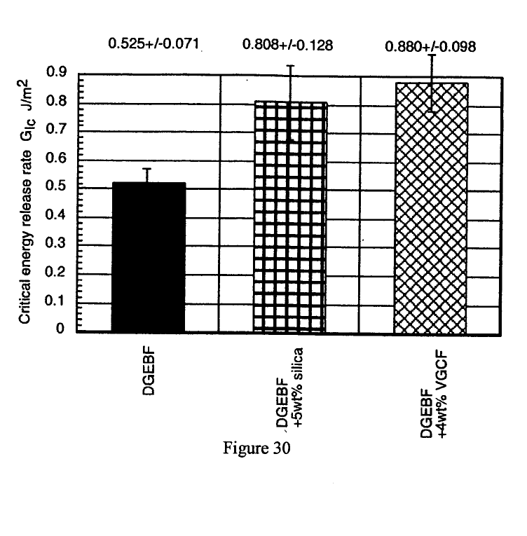

FIG. 29A shows the SEM micrograph of the fracture surface of ESO neat epoxy. As the high critical energy release rate was observed in FIG. 26, the fracture surface was extremely rough. This was clearly distinctive, compared to the completely flat fracture surface of petroleum-based and ELO neat epoxy, which did not have the second phase as shown in FIG. 29A. The rougher surface is identical for dissipating more energy due to shear deformation during the crack propagation. It was reported that the addition of the rubber particles into epoxy could cause a) localized cavitation in the rubber or the rubber/epoxy interface; and b) plastic shear yielding. For the epoxy, the critical energy release rate in Mode II, crack shearing mode, was approximately 10 times larger than that of the same epoxy in Mode I, crack opening mode. The ESO-rich rubber phase observed by SEM as shown in FIG. 30 has the same role as previously reported for petroleum-based rubber-toughened epoxy. As a result, the critical energy release rate was improved almost 10 times after 30 wt. % DGEBF was replaced by ESO.

FIGS. 29B and 29C show the fracture surfaces of ESO/exfoliated clay and ESO/intercalated clay nanocomposites, respectively. As discussed in FIG. 24, no phase separation was observed for clay/ESO nanocomposites in FIGS. 29B and 29C. Hence, the critical energy release rate of clay nanocomposites decreased, compared with the ESO neat epoxy. Comparing FIG. 29B with FIG. 29C, the surface roughness of intercalated clay nanocomposites is obviously larger than that of exfoliated clay nanocomposites, as discussed in FIGS. 28B and 28C. Indeed, the critical energy release rate of the intercalated clay/ESO nanocomposites was higher than that of the exfoliated clay/ESO nanocomposites, as discussed in FIG. 27.

### Fracture Toughness of VGCF/epoxy Nanocomposites

The non-linearity was seldom observed in load-displacement diagrams of neat epoxy and nanocomposites. Therefore, the maximum load was used to evaluate fracture toughness. FIG. 30 shows the fracture toughness K_{IC} of neat epoxy and silica and VGCF nanocomposites. The silica nanoparticles as well as intercalated clay platelets, not exfoliated clay platelets, provide higher fracture toughness after adding it to epoxy matrix. It seems that VGCF will provide even higher fracture toughness. It can be thought because of the bridging effect of VGCF having micro-order length, which is obviously larger than the plastic zone at the vicinity of the crack tip. On the other hand, it is impossible to expect improvement of fracture toughness because of the bridging effect, since the size of alumina nanowhiskers are much smaller than the plastic zone at the vicinity of the crack tip as exfoliated clay platelets are.

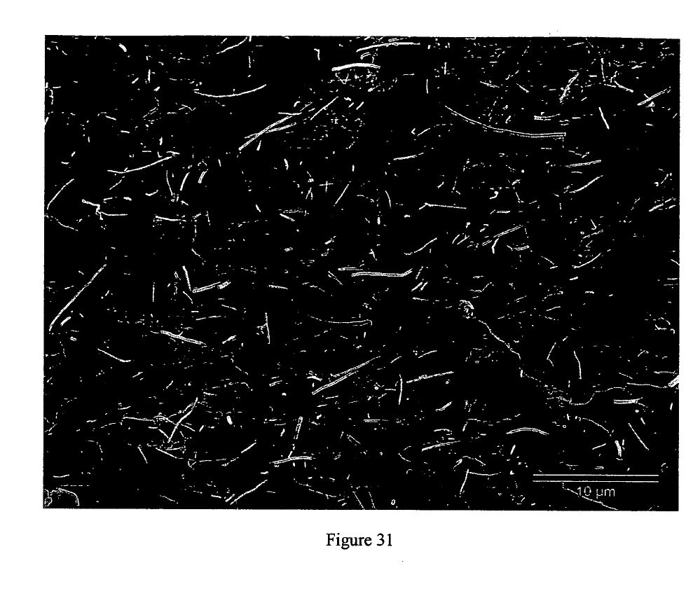

FIG. 31 shows a low magnification SEM image of the fracture surface of 4.0 wt. % VGCF/epoxy nanocomposites. The VGCF seems to be homogeneously dispersed with random orientations. The fracture surface of epoxy matrix is generally flat and a lot of VGCF were exposed in the fracture surface. This suggests that the VGCF can toughen the epoxy matrix, and the toughening mechanism is due to the bridging effect.

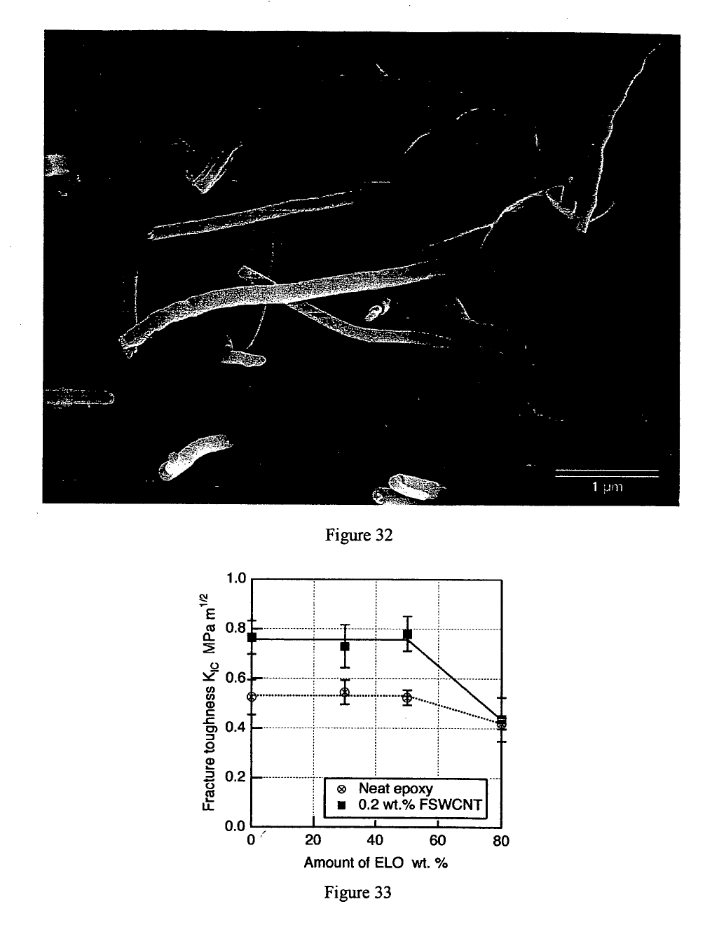

FIG. 32 shows the high magnification SEM image of the fracture surface. The debonding of the VGCF was often observed at VGCF/epoxy. This implies that the VGCF were pulled out without breaking under tensile loading. Several holes after pull out of VGCF were also observed. The aspect ratio of VGCF is large enough to improve the fracture toughness of VGCF/epoxy nanocomposites, while the high shear stress value needs to be applied to completely pull out VGCF.

### Fracture Toughness of FSWCNT/epoxy Nanocomposites

Non-linearity was seldom observed in load-displacement diagrams of different biobased neat epoxy and their FSWCNT nanocomposites. Therefore, the maximum load was used to evaluate fracture toughness. FIG. 33 shows the relation between the fracture toughness, K_{IC}, of the biobased neat epoxy, and their 0.24 wt % (0.17 vol %) FSWCNT nanocomposites with changing the amount of ELO. For biobased neat epoxies, the fracture toughness was constant for up to 50 wt % ELO. The biobased neat epoxy containing 80 wt % ELO showed lower fracture toughness. The structure of DGEBF is more rigid and straighter than the one of ELO. Consequently, the fracture toughness decreased with more than certain amount of ELO (˜50 wt %).0.24 wt % FSWCNT nanocomposites showed approximately 43% higher fracture toughness in comparison with that of the neat epoxies, when the ELO amount was up to 50 wt %. The fracture surface of the FSWCNT was observed by scanning electron microscopy (SEM). However, no exposed FSWCNT were observed, due to the excellent dispersion and to the nanoscale diameter of SWCNT (1.1 nm), which is smaller than the resolution of field emission SEM. Some of the inventors have investigated the fracture behavior of epoxy nanocomposites reinforced by vapor grown carbon fibers (VGCF) having the diameter of 100-200 nm. In this study, pulled-out VGCF from the epoxy matrix were observed on the fracture surfaces, and it was concluded that the VGCF having the high aspect ratio prevented the crack from opening and then propagating. This mechanism was known as the bridging effect. Hence, the larger stress value was distributed in front of the crack tip at the crack propagation. The aspect ratio of the FSWCN was in the range of 100-1000, and it can be thought that the well-dispersed FSWCNT having sub-micron length could also prevent the crack from opening, thus enhancing the fracture toughness. For FSWCNT nanocomposites containing 80 wt % ELO, the biobased epoxy matrix has already been weaker with the excess amount of ELO from the proper amount of ELO (˜50 wt %), and the fracture toughness was not improved with the addition of 0.24 wt % FSWCNT.

### Mechanical Properties of CFRP

Table 5 shows the volume fraction of carbon fibers in unidirectional CFRP before and after cure. First, the weight of carbon fiber fabric and the total weight of composites before and after cure were measured. The weight of the carbon fiber fabric is not changed; therefore, it is possible to estimate the weight of epoxy matrix before and after cure. The volume fraction of carbon fiber was then calculated with the density of both matrix and carbon fibers. In Table 1, it was confirmed that the different CFRP could be repeatedly processed with consistent final volume fraction of reinforcement carbon fibers.

TABLE 5
Volume fraction of unidirectional CFRP processed by compression
molding.

| | Volume fraction | Volume fraction |
|---|---|---|
| | before curing | after curing |
| Epon 862 | 0.46 | 0.685 |
| FVO 50 | 0.43 | 0.678 |
| FVO 50/ | 0.405 | 0.667 |
| Exfol. clay 2.5 wt. % | | |
| FVO 50/ | 0.369 | 0.632 |
| Inter. clay 5.0 wt. % | | |

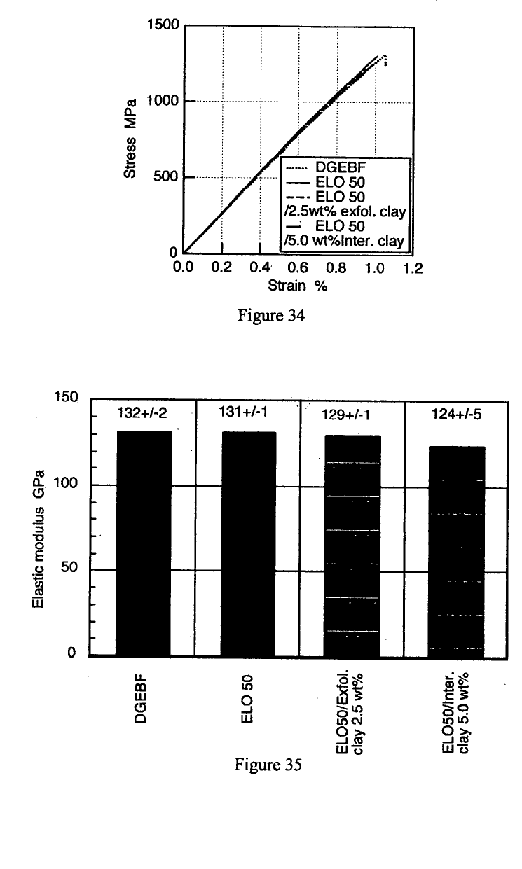

FIG. 34 shows the typical stress-strain curves of 4 different unidirectional CFRP. The stress and strain were theoretically calculated from the load and the displacement measured by an extensometer, respectively. Because of the consistent volume fraction of carbon fibers, the stress strain curves were almost the same, regardless of matrix. The CFRP did not show the plastic behavior in the stress-strain curves.

FIG. 35 shows the comparison of elastic modulus of unidirectional CFRP containing different epoxy matrix. The modulus of unidirectional CFRP was consistent regardless of different epoxy matrix, because of almost the same volume fraction of carbon fibers. The values of the elastic modulus in this Figure were slightly lower than the theoretical values calculated by the rule of mixtures, since the elastic modulus is underestimated by the flexural test because of the shear deformation.

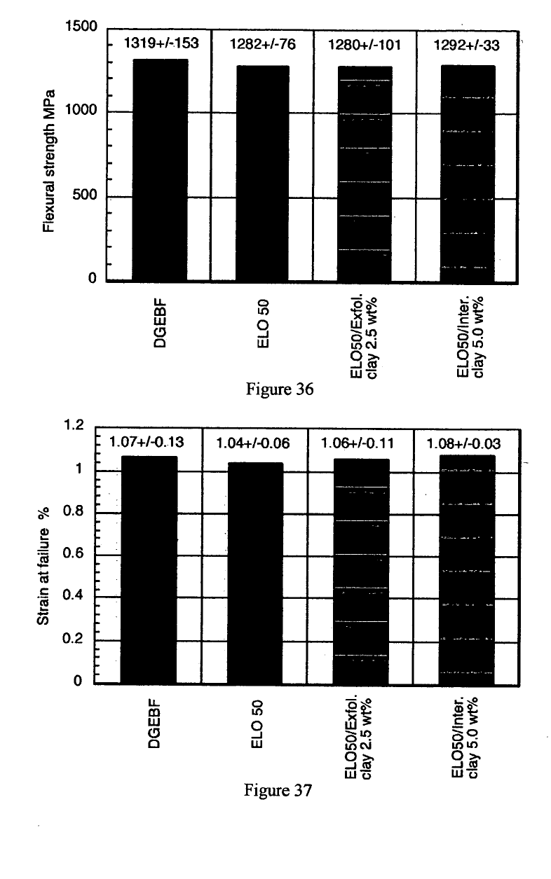

FIG. 36 shows the comparison of flexural strength of unidirectional CFRP containing different epoxy matrix. When the volume fraction of high-performance fibers is high, the strength of unidirectional FRP is dependent on the strength of the high-performance fibers. Therefore in this Figure, the unidirectional CFRP containing different epoxy matrix showed nearly the same flexural strength. From the results of FIGS. 35 and 36, it was confirmed that the bio-based epoxy would have a potential to apply for processing unidirectional or woven CFRP, which is useful for the structural application because of the same values of elastic modulus and flexural strength of CFRP.

FIG. 37 shows the comparison of ultimate strain at flexural failure. These CFRP have the high volume fraction of carbon fibers, thus the strength was determined from the strength not of the matrix but of the reinforcement carbon fibers. Also, as can be seen in stress-strain curve, the plastic behavior was not observed as the characteristics of the anhydride-cured epoxy, therefore, the strain at failure was also consistent as the strength was.

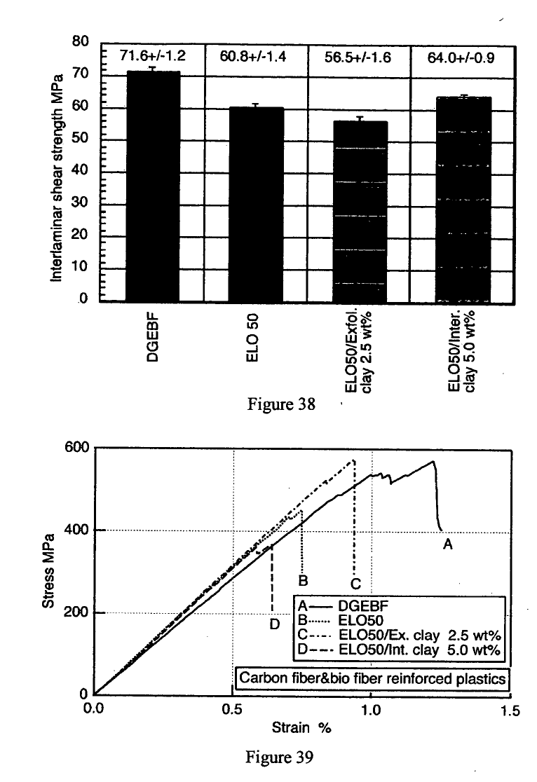

FIG. 38 shows the comparison of ILSS. In FIG. 38, the CFRP having the neat DGEBF matrix showed highest ILSS. The ILSS of the CFRP having the neat bio-based epoxy matrix clearly showed the lower ILSS than that with neat DGEBF. This weaker property of the bio-based epoxy is a current problem for their use in structural application. When 2.5 weight percent exfoliated clay nanoplatelets were added to the bio-based epoxy, the ILSS decreased. In contrast, when 5.0 weight percent intercalated clay platelets were added to the bio-based epoxy, the higher ILSS was observed in comparison to the neat bio-based epoxy. Therefore, it was possible to improve the properties with addition of clay particles with optimum extent of dispersion of clay particles in the epoxy matrix. Some of the authors (Miyagawa, H., et al., Proc. 14^{th} International Conference on Composite Materials. 2003, #2428 (CDOROM)) have already reported that with the petroleum based epoxy; the intercalated clay platelets improved the critical energy release rate, although the exfoliated clay platelets marginally improved the fracture behavior. Therefore, it can be inferred that the result of short beam shear test showed similar trends as the fracture test of nanocomposites.

### Mechanical Properties of CBFRP

Table 6 shows the volume fraction of carbon and bio fibers before and after cure. This was calculated from the weight of fibers and resin before and after cure. We could control the final volume fraction as consistent in the process of CBFRP.

TABLE 6
Volume fraction of unidirectional CBFRP processed by compression
molding.

| | CF vol % | BF vol % | CF vol % | BF vol % |
|---|---|---|---|---|
| | before curing | before curing | after curing | after curing |
| Epon 862 | 0.115 | 0.138 | 0.168 | 0.202 |
| ELO 50 | 0.122 | 0.135 | 0.184 | 0.204 |
| ELO 50/ | 0.121 | 0.125 | 0.180 | 0.186 |
| exSCP2.5 | | | | |
| wt. % | | | | |
| ELO 50/ | 0.123 | 0.121 | 0.193 | 0.190 |
| inSCP5.0 | | | | |
| wt. % | | | | |

FIG. 39 shows the typical stress strain curve of 4 different CBFRP. 4 different matrices were neat DGEBF, ELO 50 wt. %, ELO 50 wt. %/2.5 wt. % exfoliated clay (Cloisite 30B), and ELO 50 wt. %/2.5 wt. % intercalated clay (Cloisite 30B). The scattering of the modulus is because of the slight difference of volume fractions of carbon and bio fibers.

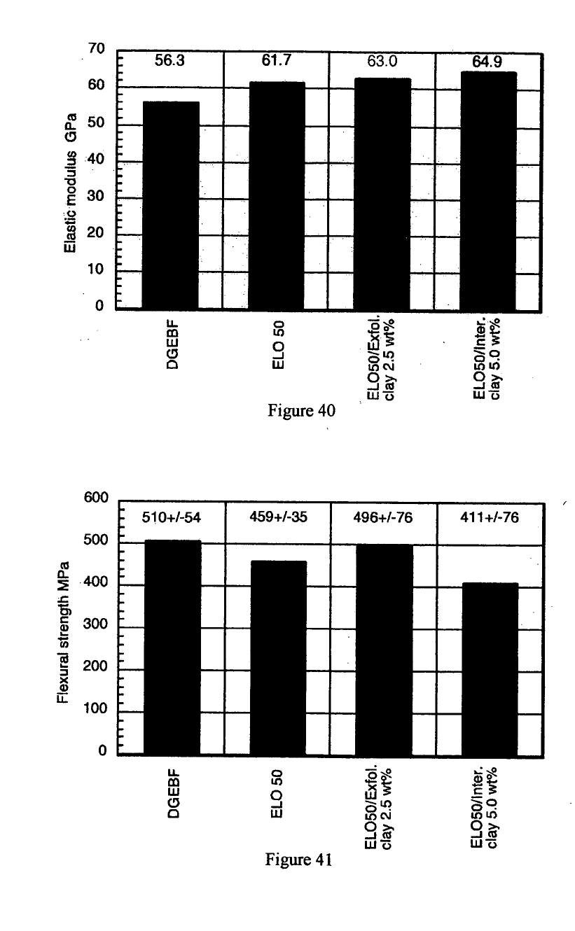

FIG. 40 shows the comparison of flexural modulus. As discussed in stress strain curve, the scattering of the modulus is because of the slight difference of volume fractions of carbon and bio fibers. The elastic modulus of the CBFRP was between 55-65 GPa, making the hybrid bio-based structural composites

FIG. 41 shows the comparison of flexural strength. These CBFRP have the lower volume fraction of carbon and bio fibers. Thus, the strength was not completely determined from the strength of reinforcement fibers. It seems that the exfoliated clay can help to improve the strength of CBFRP. However, the aggregated intercalated clay particles prepared with only magnetic stirrer without the sonication technique resulted in rather low strength. The values of flexural strength were between 411-510 MPa, regardless of different epoxy matrix.

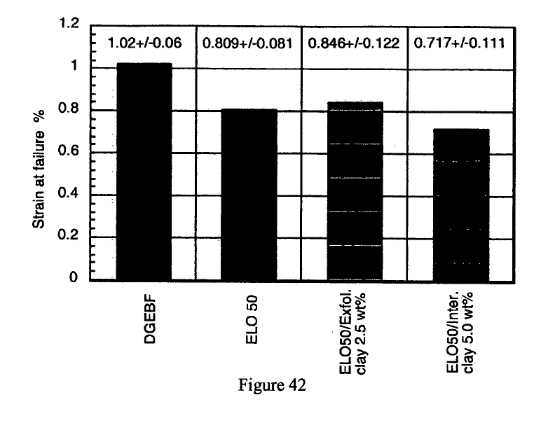

FIG. 42 shows the comparison of ultimate strain at flexural failure. As can be seen in stress-strain curve, the plastic behavior was not observed as the characteristics of the anhydride-cured epoxy.

It was found that the

Selection of anhydride curing agent and bio-based epoxy resulted in an excellent combination to provide epoxy samples having higher elastic modulus, higher glass transition temperature, and higher HDT with higher amount of functionalized vegetable oils, although it was possible to add up to only 20 wt. % ELO or ESO to process glassy epoxy with amine curing agent. We could achieve anhydride-cured 100% ELO system with high enough storage and elastic moduli.

A novel sample preparation scheme was effective to process the modified clay in the glassy bio-based epoxy network resulting in nanocomposites where the organo-clay nanoplatelets were almost completely exfoliated by the epoxy network.

A novel sample preparation scheme was effective to process the alumina nanowhiskers in the glassy bio-based epoxy network resulting in nanocomposites where the alumina nanowhiskers were homogeneously dispersed in the epoxy matrix.

A novel sample preparation scheme was effective to process the VGCF and FSWCNT in the glassy bio-based epoxy network resulting in nanocomposites where the VGCF and FSWCNT were homogeneously dispersed in the epoxy matrix.

The processed exfoliated clay nanocomposites showed higher storage modulus comparing to the neat epoxy containing the same amount of functionalized vegetable oils. Therefore, the lost storage modulus with higher amount of vegetable oils can be regained with exfoliated clay reinforcement.

The processed alumina nanowhisker nanocomposites showed remarkably higher storage modulus comparing to other nanocomposites containing the exfoliated clay platelets and VGCF.

The processed fluorinated SWCNT nanocomposites showed enormous improvement of storage modulus with extremely small amounts of SWCNT, comparing to any other nano-reinforcements.

Although the fluorination for the SWCNT was effective to disperse them in the epoxy matrix, the fluorine on the surface of FSWCNT became free radicals and broke the chains of DGEBF and ELO. This resulted in a non-stoichiometry of the biobased epoxy matrix without adjusting the amount of the anhydride curing agent. The lower cross-link density of the biobased epoxy matrix of the FSWCNT nanocomposites observed from lower glass transition temperature and lower maximum decomposition temperature.

The highest impact strength and the fracture toughness were the result of a phase separation of the ESO into rubbery particles. The rubber ESO-rich phases add a significant amount of energy to the crack propagation process.

Izod impact strength could be maintained or become even higher after the exfoliated clay platelets were added to the bio-based epoxy due to the mixture of suitable amount of epoxidized vegetable oil.

The Izod impact strength of fluorinated SWCNT nanocomposites was almost maintained after adding 0.1-0.3 wt % SWCNT, dependent on the epoxy matrix.

It was possible to achieve 100° C. as HDT with all nano-scale reinforcements. This is a promising fact for future industrial applications in automotive, aeronautical, other transportation systems, defense, and marine industries, recreation equipments, farm equipments, and electronic packaging applications such as computer mother boards, and so on from bio-based epoxy resin.

The fracture toughness and the critical energy release rate of the anhydride-cured ESO neat epoxy were the highest.

The fracture toughness and the critical energy release rate of ELO epoxy were greatly improved with the addition of intercalated clay nanoplatelets, although the addition of clay nanoplatelets into ESO epoxy resulted in the decreased fracture toughness and impact strength. These were correlated to the surface morphology observed by SEM.

Fracture toughness was clearly improved with 4.0 wt. % VGCF. It is because of the bridging effect due to the micro-scale length of VGCF, which is larger than the size of the plastic zone at the vicinity of the crack tip.

CFRP were processed using the bio-based epoxy/clay nanocomposites. No difference in elastic modulus and flexural strength was observed regardless of different matrices, because of high volume fraction of the reinforcement carbon fibers.

It was observed that the ILSS of CFRP with bio-based epoxy was improved with adding 5.0 weight percent intercalated clay nanoparticles.

CBFRP were processed using the bio-based epoxy/clay nanocomposites and bio fibers. Although small differences in elastic modulus were observed with regard to the scatter of volume fraction of carbon and bio fibers, the storage modulus was more than 55 GPa, which can be used for structural applications.

It is intended that the foregoing description be only illustrative of the present invention and that the present invention be limited only by the hereinafter appended claims.

1. A cured epoxy resin composition which comprises an epoxy resin precursor which resists biodegradation, copolymerized with an epoxidized vegetable oil precursor or an epoxidized vegetable oil ester durative of the oil.

2. The composition of claim 1 wherein the composition is derived from between about 10 and 80% by weight of the epoxidized vegetable oil precursor.

3. The composition of claim 1 or 2 which contains a filler selected from the group consisting of an organically modified clay, exfoliated nanographite platelets, inorganic nanowhiskers, nanoparticles, nanofibers, carbon nanofibers including vapor grown carbon fibers, untreated and treated carbon nanotubes and combinations thereof.

4. The composition of claim 1 or 2 which contains an intercalated or exfoliated clay.

5. The composition of claim 1 or 2 derived from the expoxidized vegetable oil precursor which is selected from the group consisting of epoxidized soybean, epoxidized linseed oil and mixtures thereof.

6. The composition of claim 1 or 2 cured with a curing agent selected from the group consisting of an anhydride and an amine curing agent.

7. The composition of claim 1 or 2 cured with a curing agent which is methyltetrahydrophthalic anhydride.

8. The composition of claim 1 or 2 cured with a curing agent which is a polyether triamine.

9. The composition of claim 1 or 2 cured with a curing agent which is polypropylene triamine.

10. A process for forming a cured epoxy resin comprising the composition of claim 1 or 2 which comprises:
(a) intercalating or exfoliating montmorillonite nanoparticles with the epoxy resin precursors; and
(b) curing the precursors with an epoxy resin curing agent.

11. The process of claim 10 wherein the precursors are mixed with a solvent and a clay as the nanoparticles and sonication to exfoliate the clay and then the solvent is removed.

12. The process of claim 10 wherein the solvent is acetone.

13. The process of claim 10 wherein the precursors are mixed with a solvent and the nanoparticles to disperse the particles homogeneously and then the solvent is removed by vacuum distillation from the precursors and the nanoparticles.

14. A process for forming a cured epoxy resin comprising the composition of claim 1 or 2 wherein the precursors are mixed with a filler.

15. A curable epoxy resin composition which comprises:
(a) a liquid mixture of an epoxy resin precursor which resists biodegradation;
(b) an epoxidized vegetable oil or derivative thereof;
(c) an epoxy curing agent; and
(d) optionally an accelerator wherein the composition is refrigerated to retard curing.

16. The composition of claim 15 further comprising a filler selected from the group consisting of an organically modified clay, exfoliated nanographite platelets, inorganic nanowhiskers, nanoparticles, nanofibers, carbon nanofibers including vapor grown carbon fibers, untreated and treated carbon nanotubes and combinations thereof.

17. The composition of claim 15 which further contains an exfoliated clay.

18. The composition of claim 15 derived from the epoxidized vegetable oil precursor which is selected from the group consisting of epoxidized soybean, epoxidized linseed oil and mixtures thereof.

19. A cured epoxy resin composition comprising of an anhydride cured epoxidized linseed oil precursor as the resin.

20. Carbon fiber and bio fiber reinforced composites which comprise the compositions of any one of claims 1, 2, 15 or 19.

21. A composite of claim 1, 2, 15 or 19 with a mat or strand of the carbon fiber and bio fiber produced by casting, compression molding, resin transfer molding or vacuum assisted resin transfer molding.

22. A process for producing a composition as in any one of claims 1, 2, 15 or 19 wherein the epoxy resin precursor composition is cured with carbon fibers and bio fibers as a mat or strand of fibers.
